(19) United States
(12) Patent Application Publication
(10) Pub. No.: US 2013/0225669 A1
(43) Pub. Date: Aug. 29, 2013

(54) STERILIZATION OF PROTEINACEOUS BIOMATERIALS AND TISSUES WITH GENIPIN

(71) Applicant: University Hospitals Cleveland Medical Center, (US)

(72) Inventors: Michael Seth Reich, Shaker Heights, OH (US); Ozan Akkus, Brooklyn, OH (US)

(73) Assignee: University Hospitals Cleveland Medical Center, Cleveland, OH (US)

(21) Appl. No.: 13/779,779

(22) Filed: Feb. 28, 2013

Related U.S. Application Data
(60) Provisional application No. 61/604,031, filed on Feb. 28, 2012.

(51) Int. Cl. A01N 43/16

(52) U.S. Cl. CPC A01N 43/16
USPC 514/456

(57) ABSTRACT

The invention contemplates a method for sterilizing protein or collagen-based hard and soft tissues, from animal and human donors or created synthetically by exposure to genipin, an active compound found in gardenia fruit extract. Genipin sterilizes the tissues through crosslinking the organic framework of microbes while maintaining or enhancing mechanical strength of the tissue graft by stabilizing the collagen backbone with crosslinks bone allografts experience significant and repetitive loads during their duty cycle, sterilizing bone allografts without causing a loss in biomechanical properties is quite important.

This application claims the benefit of priority to Provisional Application U.S. Ser. No. 61/604,031, which was filed on Feb. 28, 2012, the disclosures of which are incorporated herein by reference.

### FIELD OF THE INVENTION

The invention contemplates a method for sterilizing collagen-based hard and soft tissues, from animal and human donors or created synthetically. For example the tissues could include, but not limited to bone, cartilage, tendon, ligament, collagen scaffolds, collagen substrates, tissue meshes, cornea, and heart valves. For example, these procedures would be performed after explant of the tissue from the host, or after being prepared in the laboratory, to sterilize the graft prior to utilization in surgical procedures. Additionally, genipin fixation sterilizes the tissues through crosslinking the organic framework of microbes while maintaining or enhancing mechanical strength of the tissue graft by stabilizing the collagen backbone with crosslinks. Grafts experience significant and repetitive loads during their duty cycle, sterilizing collagen-based hard and soft tissues without causing a loss in biomechanical properties is quite important.

### BACKGROUND OF THE INVENTION

Human, animal and synthetic materials are currently used in medical procedures to augment tissue or repair or correct tissue defects. While a number of fixation and/or sterilization agents have been reported, including paracetic acid, formaldehyde and glutaraldehyde, it is clear they do not sufficiently concomitantly strengthen or sterilze tissues without toxic effects in medical uses. Therefore, there is a continued need for treatments to sterilze and strengthen protein or collagen-based hard and soft tissues.

### SUMMARY OF THE INVENTION

The invention contemplates a method for sterilizing collagen-based hard and soft tissues, from animal and human donors or created synthetically. For example the tissues could include, but not limited to bone, cartilage, tendon, ligament, collagen scaffolds, collagen substrates, tissue meshes, cornea, and heart valves. For example, these procedures would be performed after explant of the tissue from the host, or after being prepared in the laboratory, to sterilize the graft prior to utilization in surgical procedures. Additionally, genipin fixation sterilizes the tissues through crosslinking the organic framework of microbes while maintaining or enhancing mechanical strength of the tissue graft by stabilizing the collagen backbone with crosslinks. Grafts experience significant and repetitive loads during their duty cycle, sterilizing collagen-based hard and soft tissues without causing a loss in biomechanical properties is quite important.

In one embodiment, the invention contemplates a method of sterilizing protein-based tissue, comprising: (a) preparing and sterilizing a minimum 10% genipin solution, and (b) treating said protein-based tissue with said prepared, sterilized minimum 10% genipin solution under such conditions that produce a sterile crosslinked structure. In one embodiment, said crosslinked structure has stability to degradative enzymes. In one embodiment, said crosslinked structure has low acute toxicity. In one embodiment, said crosslinked structure has durability sufficient for use as a biocompatible implant. In one embodiment, said preparing and sterilizing a minimum 10% genipin solution comprises: (a) dissolving genipin in dimethyl sulfoxide at least 20 grams per 100 mL solution, (b) adding an equal volume of phosphate buffered saline to said solution, (c) agitating the solution, and (d) sterile filtering the solution. In one embodiment, said treating comprises minimum 24 hours between room temperature and 37° C. for tissue less than 1 millimeter thick. In one embodiment, said tissue is post-treated in another solution not containing genipin, such as 100% PBS or 90% ethanol. In one embodiment, wherein said treating comprises minimum 168 hours between room temperature and 37° C. for tissue greater than 1 millimeter thick. In one embodiment, said tissue is post-treated in another solution not containing genipin, such as 100% PBS or 90% ethanol. In one embodiment, wherein said treating comprises soaking said protein-based tissue with said prepared, sterilized minimum 10% genipin solution within 15 minutes of the solution preparation. In one embodiment, said treating sterilizes the tissues through crosslinking the organic framework of microbes while maintaining or enhancing mechanical strength of the tissue. In one embodiment, said protein-based tissue is selected from the group consisting of: collagen-based hard and soft tissue from animal and human donors or synthetically created tissue. In one embodiment, said protein-based tissue is selected from the group consisting of: bone, cartilage, tendon, ligament, collagen scaffold, collagen substrate, tissue mesh, cornea, and heart valve. In one embodiment, said treating occurs at a maximum temperature just below the substrate's denaturation temperature. In one embodiment, said solution is prepared with at least one organic solvent. In one embodiment, said organic solvent is dimethyl sulfoxide. In one embodiment, organic solvent is dimethylformamide. In one embodiment, said treatment occurs at a pressure is selected from the group consisting of atmospheric pressure, within a pressurized system, within a negative pressure environment, or under vacuum. In one embodiment, said solution is prepared in a cold environment, and treatment occurs at temperatures ≧25° C. In one embodiment, said cold environment is <10° C. In one embodiment, said treatment reduces bioburden allowing for decreasing the dose of alternative sterilization process. In one embodiment, said treatment occurs before the alternative sterilization process. In one embodiment, said treatment occurs after the alternative sterilization process.

In one embodiment, the invention contemplates a method of sterilizing protein-based tissue, comprising: (a) preparing and sterilizing a minimum 0.01% genipin solution, and (b) treating said protein-based tissue with said prepared, sterilized minimum 0.01% genipin solution under such conditions that produce a sterile crosslinked structure. In one embodiment, said crosslinked structure has stability to degradative enzymes. In one embodiment, said crosslinked structure has low acute toxicity. In one embodiment, said crosslinked structure has durability sufficient for use as a biocompatible implant. In one embodiment, said preparing and sterilizing a minimum 0.01% genipin solution comprises: (a) dissolving genipin in phosphate buffered saline at least 0.02 grams per 100 mL solution, or (b) agitating the solution, and (c) sterile filtering the solution. In one embodiment, said treating comprises minimum 72 hours between room temperature and 37° C. for tissue less than 1 millimeter thick. In one embodiment, said tissue is post-treated in another solution not containing genipin, such as 100% PBS or 90% ethanol. In one embodiment, said treating comprises minimum 168 hours between room temperature and 37° C. for tissue greater than 1 millimeter thick. In one embodiment, said tissue is post-treated in another solution not containing genipin, such as 100% PBS or 90% ethanol. In one embodiment, said treating comprises soaking said protein-based tissue with said prepared, sterilized minimum 0.63% genipin solution within 15 minutes of the solution preparation. In one embodiment, said treating occurs at a maximum temperature just below the substrate's denaturation temperature. In one embodiment, said solution is prepared with at least one organic solvent. In one embodiment, said organic solvent is dimethyl sulfoxide. In one embodiment, said organic solvent is dimethylformamide. In one embodiment, said treatment occurs under various pressures selected from the group consisting of: atmospheric pressure, within a pressurized system, within a negative pressure environment, or under vacuum. In one embodiment, said solution is prepared in a cold environment, <10° C., and treatment occurs at temperatures ≧25° C. In one embodiment, said treatment reduces bioburden allowing for decreasing the dose of alternative sterilization process. In one embodiment, said treatment occurs before an alternative sterilization process. In one embodiment, said treatment occurs after an alternative sterilization process.

In one embodiment, the invention contemplates a method of sterilizing non-protein based materials contaminated with protein-based matter, comprising: (a) preparing and sterilizing a minimum 10% genipin solution, and (b) treating said non-protein-based material with said prepared, sterilized minimum 10% genipin solution under such conditions that produce a sterile structure with crosslinked bioburden. In one embodiment, said preparing and sterilizing a minimum 10% genipin solution comprises: (a) dissolving genipin in dimethyl sulfoxide at least 20 grams per 100 mL solution, (b) adding an equal volume of phosphate buffered saline to said solution, (c) agitating the solution, and (d) sterile filtering the solution. In one embodiment, said treating comprises minimum 24 hours between room temperature and 37° C. In one embodiment, said treating comprises soaking said protein-based tissue with said prepared, sterilized minimum 10% genipin solution within 15 minutes of the solution preparation. In one embodiment, said treating sterilizes the material through crosslinking the organic framework of microbes. In one embodiment, said non-protein based material is a biocompatible implant. In one embodiment, said non-protein based material consists of polyethylene, metals, surgical equipment, and plastics.

In one embodiment, the invention contemplates a method of non-organic materials contaminated with protein-based matter, comprising: (a) preparing and sterilizing a minimum 0.01% genipin solution, and (b) treating said material protein-based tissue with said prepared, sterilized minimum 0.01% genipin solution under such conditions that produce a sterile structure with crosslinked bioburden. In one embodiment, said non-organic material is a biocompatible implant. In one embodiment, said treating comprises minimum 24 hours between room temperature and 37° C. of a washed non-protein based material. In one embodiment, said treating comprises soaking said protein-based tissue with said prepared, sterilized minimum 0.01% genipin solution within 15 minutes of the solution preparation. In one embodiment, said treating sterilizes the material through crosslinking the organic framework of microbes. In one embodiment, said non-protein based material is a biocompatible implant. In one embodiment, said non-protein based material consists of polyethylene, metals, surgical equipment, and plastics.

In one embodiment, the invention contemplates a method of sterilizing protein-based tissue, comprising: (a) preparing and sterilizing a minimum 10% genipin solution, and (b) treating said protein-based tissue with said prepared, sterilized minimum 10% genipin solution under such conditions that produce a sterile crosslinked structure, said crosslinked structure having stability to degradative enzymes, low acute toxicity, and durability sufficient for use as a biocompatible implant. In one embodiment, said preparing and sterilizing a minimum 10% genipin solution comprises: (a) dissolving genipin in dimethyl sulfoxide at least 20 grams per 100 mL solution, (b) adding an equal volume of phosphate buffered saline to said solution, (c) agitating the solution, and (d) sterile filtering the solution. In one embodiment, said treating comprises minimum 24 hours between room temperature and 37° C. for tissue less than 1 millimeter thick. In one embodiment, said tissue is post-treated in another solution not containing genipin, such as 100% PBS or 90% ethanol. In one embodiment, said treating comprises minimum 168 hours between room temperature and 37° C. for tissue greater than 1 millimeter thick. In one embodiment, said tissue is post-treated in another solution not containing genipin, such as 100% PBS or 90% ethanol. In one embodiment, said treating comprises soaking said protein-based tissue with said prepared, sterilized minimum 10% genipin solution within 15 minutes of the solution preparation. In one embodiment, said treating sterilizes the tissues through crosslinking the organic framework of microbes while maintaining or enhancing mechanical strength of the tissue. In one embodiment, said protein-based tissue comprises: collagen-based hard and soft tissues from animal and human donors or created synthetically. In one embodiment, aid protein-based tissue comprises: bone, cartilage, tendon, ligament, collagen scaffolds, collagen substrates, tissue meshes, cornea, and heart valves. In one embodiment, said treating occurs at a maximum temperature just below the substrate's denaturation temperature. In one embodiment, solutions are prepared with organic solvents. In one embodiment, said organic solvent is dimethylformamide. In one embodiment, said treatment occurs under various pressures including, but not limited to atmospheric pressure, within a pressurized system, within a negative pressure environment, or under vacuum. In one embodiment, said solutions are prepared in a cold environment, <10° C., and treatment occurs at temperatures ≧25° C. In one embodiment, said treatment reduces bioburden allowing for decreasing the dose of alternative sterilization process or methods (ie: gamma radiation, ethylene oxide, steam). In one embodiment, said treatment occurs before the alternative sterilization process. In one embodiment, said treatment occurs after the alternative sterilization process.

In one embodiment, the invention contemplates a method of sterilizing protein-based tissue, comprising: (a) preparing and sterilizing a minimum 0.01% genipin solution, and (b) treating said protein-based tissue with said prepared, sterilized minimum 0.01% genipin solution under such conditions that produce a sterile crosslinked structure, said crosslinked structure having stability to degradative enzymes, low acute toxicity, and durability sufficient for use as a biocompatible implant. In one embodiment, said preparing and sterilizing a minimum 0.01% genipin solution comprises: (a) dissolving genipin in phosphate buffered saline at least 0.02 grams per 100 mL solution, or (b) dissolving genipin in DMSO and then PBS such that the final mass of genipin is 0.02 grams per 100 mL solution and the ratio of DMSO:PBS does not exceed 1:1, (c) agitating the solution, and (d) sterile filtering the solution. In one embodiment, said treating comprises minimum 72 hours between room temperature and 37° C. for tissue less than 1 millimeter thick. In one embodiment, said tissue is post-treated in another solution not containing genipin, such as 100% PBS or 90% ethanol. In one embodiment, said treating comprises minimum 168 hours between room temperature and 37° C. for tissue greater than 1 millimeter thick. In one embodiment, said tissue is post-treated in another solution not containing genipin, such as 100% PBS or 90% ethanol. In one embodiment, said treating comprises soaking said protein-based tissue with said prepared, sterilized minimum 0.63% genipin solution within 15 minutes of the solution preparation. In one embodiment, said treating occurs at a maximum temperature just below the substrate's denaturation temperature. In one embodiment, said solutions are prepared with other organic solvents such as dimethylformamide instead of dimethyl sulfoxide. In one embodiment, said treatment occurs various pressures including, but not limited to atmospheric pressure, within a pressurized system, within a negative pressure environment, or under vacuum. In one embodiment, said solutions are prepared in a cold environment, <10° C., and treatment occurs at temperatures ≧25° C. In one embodiment, said treatment reduces bioburden allowing for decreasing the dose of alternative sterilization process or methods required (ie: gamma radiation, ethylene oxide, steam). In one embodiment, said treatment occurs before the alternative sterilization process. In one embodiment, said treatment occurs after the alternative sterilization process.

In one embodiment, the invention contemplates a method of sterilizing non-protein based materials contaminated with protein-based matter, comprising: (a) preparing and sterilizing a minimum 10% genipin solution, and (b) treating said non-protein-based material with said prepared, sterilized minimum 10% genipin solution under such conditions that produce a sterile structure with crosslinked bioburden. In one embodiment, said preparing and sterilizing a minimum 10% genipin solution comprises: (a) dissolving genipin in dimethyl sulfoxide at least 20 grams per 100 mL solution, (b) adding an equal volume of phosphate buffered saline to said solution, (c) agitating the solution, and (d) sterile filtering the solution. In one embodiment, said treating comprises minimum 24 hours between room temperature and 37° C. In one embodiment, said treating comprises soaking said protein-based tissue with said prepared, sterilized minimum 10% genipin solution within 15 minutes of the solution preparation. In one embodiment, said treating sterilizes the material through crosslinking the organic framework of microbes. In one embodiment, said non-protein based material is a biocompatible implant. In one embodiment, said non-protein based materials include polyethylene, metals, surgical equipment, and plastics.

In one embodiment, the invention contemplates a method of non-organic materials contaminated with protein-based matter, comprising: (a) preparing and sterilizing a minimum 0.01% genipin solution, and (b) treating said material protein-based tissue with said prepared, sterilized minimum 0.01% genipin solution under such conditions that produce a sterile structure with crosslinked bioburden. In one embodiment, said non-organic materials is a biocompatible implant. In one embodiment, said treating comprises minimum 24 hours between room temperature and 37° C. of a washed non-protein based material. In one embodiment, said treating comprises soaking said protein-based tissue with said prepared, sterilized minimum 0.01% genipin solution within 15 minutes of the solution preparation. In one embodiment, said treating sterilizes the material through crosslinking the organic framework of microbes. In one embodiment, said non-protein based material is a biocompatible implant. In one embodiment, said non-protein based materials include polyethylene, metals, surgical equipment, and plastics.

In one embodiment, a genipin solution can be used to sterilize inert materials (polyethylene, metals, etc) that are dipped in genipin solution to crosslink whatever microbes, viruses, or other potential sources of contamination are on the surface thus sterilizing non-protein based materials.

In one embodiment, the effective range of genipin solution may be broadly from low concentrations, such as 0.01%, to solution saturation (as much as is dissolvable or until precipitates provided it's >0.63% in PBS). In one embodiment, the solution may be up to 75% genipin in DMSO. In one embodiment, the solution may not contain DMSO. In one embodiment, the solution may contain dimethylformamide. It is not intended that the present invention be limited by the nature of the solution used to dissolve genipin. Moreover, the present invention contemplates various solutions used continuously or changed at intervals during and after the treatment of tissues with genipin. It is not intended that the present invention be limited by the nature of the source of tissues crosslinked by the current invention. In one embodiment, the tissues are protein-based hard and soft tissues, from animal and human donors or created synthetically, including, but not limited to bone, cartilage, tendon, ligament, collagen scaffolds, tissue meshes, cornea, heart valves, skin, lab-based collagen or proteinaceous substrates (including drug delivery systems), and lab-created tissues. In one embodiment, the tissues are collagen-based hard and soft tissues, from animal and human donors or created synthetically, including, but not limited to bone, cartilage, tendon, ligament, collagen scaffolds, tissue meshes, cornea, and heart valves. Moreover, the present invention contemplates the combination of various tissue sources for genipin crosslinking sterilzation.

It is not intended that the present invention be limited by the nature of the source of genipin used for crosslinking. The present invention also contemplates the addition of other components (e.g., inert or bioactive) without affecting the methods of the present invention.

In one embodiment, the present invention contemplates crosslinking treatment of tissues at a range of temperatures. In one embodiment, the invention considers temperatures short of the denaturation temperatures for the given tissue. In one embodiment, the temperature of the solution can reach 100° C. In one embodiment, said treatment occurs various pressures including, but not limited to atmospheric pressure, within a pressurized system, within a negative pressure environment, or under vacuum. In some embodiments, the invention contemplates treating the tissues with solution under an atmospheric pressure other than standard pressure. In some embodiments, the invention contemplates treating the tissues with solution under an atmospheric pressure other than standard pressure or room temperature. In some embodiments, the invention contemplates treating the tissues with solution under a pressurized atmosphere.

In one embodiment, the present invention contemplates post-treatment processing. In one embodiment, the invention involves treating said tissue with genipin in a DMSO:PBS solution, then subsequently treat (post-treatment) with a solution not containing genipin. In one embodiment, said subsequent treatment is 100% PBS or 90% ethanol. In one embodiment, said post-treatment further matures genipin crosslinks. In one embodiment, the invention contemplates exposure to genipin containing solutions and subsequent treatment with or without genipin wherein the solvents, exposure duration, temperature, and pressure may be varied. In one embodiment, the invention contemplates exposure to genipin containing solutions and subsequent treatment without genipin wherein the solvents, exposure duration, temperature, and pressure may be varied.

In one embodiment, the invention contemplates serially changing genipin containing solutions in the treatment of tissues. In one embodiment, the invention contemplates constant mixing or shaking of said solutions. In one embodiment, the invention contemplates preparation of genipin containing solutions in a cold environment to limit autopolymerization. In some embodiments, treatment of said tissues in a warm environment, such as room temperature (25° C.) or 37° C. Bone and soft tissue allografts experience significant and repetitive loads during their duty cycle, sterilizing collagen-based hard and soft tissues without causing a loss in biomechanical properties is quite important. In one embodiment, the current invention enhances resistance to fatigue failure, allowing it to endure more cycles of loading than even a native tissue. Grafts tend to be stronger than the native tissue because their properties deteriorate much faster (ie in ACL reconstruction). In one embodiment, genipin can be used to enhance an already sterilized graft's properties even when genipin is not primarily used as a sterilant. In one embodiment, genipin can be used to protect from damage gamma irradiated sterilized bone and soft tissues. In one embodiment, genipin can be used to repair damage induced by gamma irradiated sterilized bone and soft tissues while maintaining graft sterility. In one embodiment, genipin can be used to pre-treat grafts that are to be sterilized with gamma radiation, therefore reducing the pre-radiation bioburden thus permitting use of a lower radiation dose (which would decrease the amount of damage done by gamma radation).

In one embodiment, the invention contemplates a method of sterilzing collagenous tissue, comprising: (a) freshly preparing and sterilizing a minimum 10% genipin solution, and (b) treating said collagenous tissue with said freshly prepared minimum 10% genipin solution under such conditions that produce a sterile crosslinked structure, said crosslinked structure having stability to degradative enzymes, low acute toxicity, and durability sufficient for use as a biocompatible implant. In one embodiment, said freshly preparing a minimum 10% genipin solution comprises: (a) dissolving genipin in dimethyl sulfoxide at least 20 grams per 100 mL solution, (b) adding an equal volume of phosphate buffered saline to said solution, (c) agitating the solution, and (d) sterile filtering the solution. In one embodiment, said treating comprises minimum 24 hours between room temperature and 37° C. for tissue less than 1 millimeter thick. In one embodiment, said treating comprises minimum 168 hours between room temperature and 37° C. for tissue greater than 1 millimeter thick. In one embodiment, said treating comprises soaking said collagenous tissue with said freshly prepared minimum 10% genipin solution within 15 minutes of the solution preparation. In one embodiment, said treating sterilizes the tissues through crosslinking the organic framework of microbes while maintaining or enhancing mechanical strength of the tissue. In one embodiment, said collagenous tissue comprises bone, cartilage, tendon, ligament, cornea, and heart valves.

In one embodiment, the invention contemplates a method of sterilzing collagenous tissue, comprising: (a) dissolving genipin in dimethyl sulfoxide a maximum of 1.26 grams per 100 mL solution, (b) adding phosphate buffered saline to said solution such that the final ratio of DMSO:PBS is a maximum of 1:1 and final the concentration of genipin is 0.63%, (c) agitating the solution, and (d) sterile filtering the solution. In one embodiment, the invention contemplates a method of sterilzing collagenous tissue, comprising: (a) dissolving genipin in phosphate-buffered saline at least 0.63 grams per 100 mL solution, (b) agitating the solution, and (c) sterile filtering the solution. In one embodiment, treating said collagenous tissue with said prepared minimum 0.63% genipin solution under such conditions that produce a sterile crosslinked structure, said crosslinked structure having stability to degradative enzymes, low acute toxicity, and durability sufficient for use as a biocompatible implant. In one embodiment, said treating comprises minimum 24 hours between room temperature and 37° C. for tissue less than 1 millimeter thick. In one embodiment, said treating comprises minimum 168 hours between room temperature and 37° C. for tissue greater than 1 millimeter thick. In one embodiment, said treating comprises soaking said collagenous tissue with said prepared minimum 0.63% genipin solution within 15 minutes of the solution preparation.

### DEFINITIONS

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term genipin refers to an aglycone derived from an iridoid glycoside called geniposide present in fruit of Gardenia jasminoides. Genipin has the following structure:

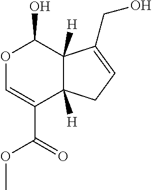 [SMILES: COC(=O)C1=CO[C@@H](O)[C@@H]2C(CO)=CC[C@H]12]

and has the IUPAC name methyl (1R,2R,6S)-2-hydroxy-9-(hydroxymethyl)-3-oxabicyclo [4.3.0]nona-4,8-diene-5-carboxylate. As used herein, the term genipin should also be understood as referring to derivatives of genipin both natural and synthetic. The cytotoxicity of genipin was previously studied in vitro using 3T3 fibroblasts, indicating that genipin is substantially less cytotoxic than glutaraldehyde (Sung H W et al., J Biomater Sci Polymer Edn 1999; 10:63-78) [1]. Additionally, the genotoxicity of genipin was tested in vitro using Chinese hamster ovary (CHO-K1) cells, suggesting that genipin does not cause clastogenic response in CHO-K1 cells (Tsai C C et al., J Biomed Mater Res 2000; 52:58-65) [2]. A biological material treated with genipin resulting in acceptable cytotoxicity is key to biomedical applications.

Collagen is a group of naturally occurring proteins found in animals, especially in the flesh and connective tissues of mammals. It is the main component of connective tissue, and is the most abundant protein in mammals (Di Lullo, G. A. et al., 2002) [3], making up about 25% to 35% of the whole-body protein content. Collagen, in the form of elongated fibrils, is mostly found in fibrous tissues such as tendon, ligament and skin, and is also abundant in cornea, cartilage, bone, blood vessels, the gut, and intervertebral disc.

The term “tissue” is used throughout the specification to describe protein or collagen-based hard and soft tissues, from animal and human donors or created synthetically or artificially, including, but not limited to bone, cartilage, tendon, ligament, collagen scaffolds, collagen substrates, tissue meshes, cornea, and heart valves.

The term “allotransplantation” is used throughout the specification to describe the transplantation of cells, tissues, or organs, to a recipient from a (genetically non-identical) donor of the same species. The transplant is called an allograft or allogeneic transplant or homograft. Most human tissue and organ transplants are allografts. In contrast, a transplant from another species is a xenograft. A transplanted organ or tissue from a genetically identical donor (such as an identical twin) is an isograft. When a tissue is transplanted from one site to another on the same patient, it is an autograft. In bone marrow transplantation, a genetically identical graft is syngeneic [4], whereas the equivalent of an autograft is termed autologous transplantation [5].

The term “collagen scaffolds” is used throughout the specification to describe naturally produced and synthetically produced structures of various shapes that have a significant portion of their sturture comprised of collagen. In one embodiment, Glowacki and Mizuno (2008) describes several types of collagen scaffolds [6]. Injectable collagen and other materials have been used clinically for a wide variety of pathological and cosmetic applications in the fields of reconstructive surgery, dermatology, oncology, otolaryngology and urology. Currently, the most widely used form of injectable collagen is derived from crosslinked bovine Type I collagen. In human clinical applications the effect of this xenogenic transplant is resorption by the human host. Examples of such materials may be found in U.S. Pat. Nos. 4,582,640 [7]; 5,104,957 [8]; 5,728,752 [9]; and 5,739,176 [10]. Human collagen that may be injected is currently available. This material it typically derived from autologous collagen obtained during elective surgery or allogenic collagen from cadavers. The starting material is dissociated by mechanical means and chemically treated to remove all noncollagenous proteins. The collagen is treated with additional chemicals to mask or crosslink the adverse effects of these damaged and exposed collagen fibers. More information with regard to this technology may be found in U.S. Pat. Nos. 4,969,912 [11] and 5,332,802 [12].

The term “tissue mesh” is used throughout the specification to describe a type of collagen scaffold that is artificially made into a thin mesh shape for use. An example of which is AlloDerm®, produced by LifeCell Corporation, which is an acellular tissue matrix which is produced from normal human skin using processing techniques established to remove the epidermis and cells within the dermis without significantly altering the normal biochemistry and molecular architecture of the connective tissue matrix. More information with regard to this technology may be found in U.S. Pat. Nos. 6,933,326 [13] and 7,358,284 [14].

The term “bioburden” is used throughout the specification to describe the degree of microbial contamination or microbial load; or the number of microorganisms contaminating an object. “Bioburden” is also considered to be the number of contaminating microbes on a certain amount of material prior to that material being sterilized.

The term “patient” or “subject” is used throughout the specification to describe an animal, generally a mammal and preferably a human, to whom treatment, including prophylactic treatment, with the compositions according to the present invention is provided. In certain embodiments, the patient or subject is a primate. Non-limiting examples of human subjects are adults, juveniles, infants and fetuses. For treatment of conditions or disease states which are specific for a specific animal such as a human patient, the term patient refers to that specific animal.

“Prevention” or “preventing” includes: (1) inhibiting the onset of a disease in a subject or patient which may be at risk and/or predisposed to the disease but does not yet experience or display any or all of the pathology or symptomatology of the disease, and/or (2) slowing the onset of the pathology or symptomatology of a disease in a subject or patient which may be at risk and/or predisposed to the disease but does not yet experience or display any or all of the pathology or symptomatology of the disease.

As used herein, the terms “treat” and “treating” is used throughout the specification to describe a step or several steps of a process to achieve a goal. In particular, most treatments considered include the process of sterilization by exposure to a genipin solution. Additionally, as used herein, the terms “treat” and “treating” are not limited to the case where the subject or material (e.g. tissue, substrate, or patient) is cured and the disease is eradicated or material sterilized. Rather, the present invention also contemplates treatment that merely reduces symptoms, improves (to some degree) and/or delays disease progression. It is not intended that the present invention be limited to instances wherein a disease, infection, or affliction is cured. It is sufficient that symptoms are reduced.

As used herein, the terms “post-treat” and “post-treating” is used throughout the specification to describe a steps in a a process subsequent to the initial tissue or substrate sterilization step.

As used herein, the terms “sterilization” is used throughout the specification to describe a term referring to any process that eliminates (removes) or kills all forms of microbial life, including transmissible agents (such as fungi, bacteria, viruses, spore forms, etc.) present on a surface, contained in a fluid, in a compound such as biological culture media, or tissue or substrate. The term “sterilization” also includes the disabling or destruction of infectious proteins such as prions.

As used herein, the terms “alternative sterilization” is used throughout the specification to describe sterilization can be achieved by applying the proper combinations of heat, chemicals, irradiation, high pressure, and filtration other than the application of genipin as described throughout the specification. Some examples of alternative sterilization” methods include: gamma rays, electron beam processing, X-rays, ultraviolet light, silver ions and silver compounds, dry sterilization process, ozone, and other chemical, temperature, and pressure methods.

As used herein, the terms “degradative enzymes” is used throughout the specification to describe enzymes (in broader sense protein) which degrade biological molecules. Some examples of degradative enzymes include, but are not limited to lipases, which digest lipids; carbohydrates, which digest carbohydrates (e.g., sugars); proteases, which digest proteins; and nucleases, which digest nucleic acids.

As used herein, the terms “acute toxicity” is used throughout the specification to describe the harmful effect of a toxic agent that manifests itself in seconds, minutes, hours, or days after entering the patient.

As used herein, the terms “low acute toxicity” is used throughout the specification to describe a significantly small toxicity effect from the tissue or substrate after genipin treatment.

As used herein, the terms “biocompatible implant” is used throughout the specification to describe material that is substantially immune to the effects of rejection.

As used herein, the terms “denaturation temperature” is used throughout the specification to describe a temperature at which the denaturation process in which proteins or nucleic acids lose the tertiary structure and secondary structure, which is present in their native state, by application of some external stress, occurs.

As used herein, the terms “soaking” is used throughout the specification to describe to immerse in and become saturated by or permeated with a given solution.

The present invention contemplates the above-described compositions in “therapeutically effective amounts” or “pharmaceutically effective amounts”, which means that amount which, when administered to tissues is sufficient to effect such treatment for the disease, infection, or to ameliorate one or more symptoms of a disease or condition (e.g. ameliorate pain).

Peracetic acid (also known as peroxyacetic acid, or PAA), is an organic compound with the formula CH₃CO₃H.

The term “salts”, as used herein, refers to any salt that complexes with identified compounds contained herein while retaining a desired function, e.g., biological activity. Examples of such salts include, but are not limited to, acid addition salts formed with inorganic acids (e.g. hydrochloric acid, hydrobromic acid, sulfuric acid, phosphoric acid, nitric acid, and the like), and salts formed with organic acids such as, but not limited to, acetic acid, oxalic acid, tartaric acid, succinic acid, malic acid, fumaric acid, maleic acid, ascorbic acid, benzoic acid, tannic acid, pamoic acid, alginic acid, polyglutamic, acid, naphthalene sulfonic acid, naphthalene disulfonic acid, and polygalacturonic acid. Pharmaceutically acceptable salts also include base addition salts which may be formed when acidic protons present are capable of reacting with inorganic or organic bases. Suitable pharmaceutically-acceptable base addition salts include metallic salts, such as salts made from aluminum, calcium, lithium, magnesium, potassium, sodium and zinc, or salts made from organic bases including primary, secondary and tertiary amines, substituted amines including cyclic amines, such as caffeine, arginine, diethylamine, N-ethyl piperidine, histidine, glucamine, isopropylamine, lysine, morpholine, N-ethyl morpholine, piperazine, piperidine, triethylamine, trimethylamine. All of these salts may be prepared by conventional means from the corresponding compound of the invention by reacting, for example, the appropriate acid or base with the compound of the invention. Unless otherwise specifically stated, the present invention contemplates pharmaceutically acceptable salts of the considered pro-drugs.

In addition, atoms making up the compounds of the present invention are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C. Similarly, it is contemplated that one or more carbon atom(s) of a compound of the present invention may be replaced by a silicon atom(s). Furthermore, it is contemplated that one or more oxygen atom(s) of a compound of the present invention may be replaced by a sulfur or selenium atom(s).

In structures wherein stereochemistry is not explicitly indicated, it is assumed that either stereochemistry is considered and all isomers claimed.

Any undefined valency on an atom of a structure shown in this application implicitly represents a hydrogen atom bonded to the atom. Bonds to copper (Cu) metal may be coordinate bonds and are not necessarily considered covalent.

The term “effective,” as that term is used in the specification and/or claims, means adequate to accomplish a desired, or hoped for result.

The term “hydrate” when used as a modifier to a compound means that the compound has less than one (e.g., hemihydrate), one (e.g., monohydrate), or more than one (e.g., dihydrate) water molecules associated with each compound molecule, such as in solid forms of the compound.

An “isomer” of a first compound is a separate compound in which each molecule contains the same constituent atoms as the first compound, but where the configuration of those atoms in three dimensions differs.

The invention contemplates that for any stereocenter or axis of chirality for which stereochemistry has not been defined, that stereocenter or axis of chirality can be present in its R form, S form, or as a mixture of the R and S forms, including racemic and non-racemic mixtures.

As used herein, “room temperature” or “RT” refers to approximately 25° C.

### DESCRIPTION OF THE FIGURES

The accompanying figures, which are incorporated into and form a part of the specification, illustrate several embodiments of the present invention and, together with the description, serve to explain the principles of the invention. The figures are only for the purpose of illustrating a preferred embodiment of the invention and are not to be construed as limiting the invention.

FIG. 1 shows a picture of bone specimen after one week of treatment at room temperature (25° C.). Note the fine light green line centrally in the genipin/PBS specimens demonstrating the two-color pigmentation in that group.

FIG. 2 shows a picture of bone specimen after one week of treatment at room temperature (25° C.). The shell is dark blue-green (left) after treatment with 0.625% in PBS and 2.0% genipin in 90% ethanol. The shell extends deeper and the core is brown with 2.0% genipin compared to a brown rim and white core in 0.625% genipin-treated bone.

FIG. 3 shows eight-bit bone color means broken into red, green, and blue components after treatment with 0.625% genipin in PBS for 24 hours, 72 hours, and one week at room temperature (25° C.). “mL” indicates volume of 0.625% genipin in PBS. Red, green, and blue colors increase in intensity (lower number indicates greater intensity) with increasing quantities of genipin and increasing durations of treatment.

FIG. 4 shows spore strips in Releasat® medium after 72 hours. Yellow indicates bacterial growth, whereas orange (baseline), indicates sterility. The darker color of the genipin/PBS group compared to the untreated control group is attributed to genipin pigment leaching from the spore strips and reacting with amino groups in the medium. An unused vial is included for color comparison.

FIG. 5a shows sporicidal effects of 2%-10% genipin in 1:1 DMSO:PBS compared to 10% formalin treated controls after 24 hours of treatment at room temperature (25° C.) with genipin as demonstrated by the number of vials without evidence of bacterial growth. Note the absence of vials without gross bacterial growth at all time points in the 2%, and 6% genipin treatment groups.

FIG. 5b shows representative Releasat® vials with B. subtilis spore strips treated for 24 hours at room temperature (25° C.) with genipin and incubated for one week. Note the yellow (growth) of the 2, 6, and 10% genipin treated spore strips and the orange (sterile) color of the formalin treated strip. An unused vial is included for color comparison.

FIG. 6a shows sporicidal effects of 0%-10% genipin in 1:1 DMSO:PBS compared to 10% formalin treated controls after 72 hours of treatment at room temperature (25° C.) with genipin as demonstrated by the number of sterile vials. Two −10% genipin demonstrate at least 6-log reductions in spore viability (all statistically significant at p≦0.05).

FIG. 6b shows representative Releasat® vials with B. subtilis spore strips treated for 72 hours at room temperature (25° C.) with genipin and incubated for one week. Note the orange (sterile) color of all groups. An unused vial is included for color comparison.

FIG. 7 shows sporicidal effects of 0.03%-0.63% genipin in PBS and 1:1 DMSO:PBS compared to 10% formalin treated controls after 72 hours of treatment at room temperature (25° C.) as demonstrated by the number of sterile vials. Greater than a 5-log reduction is noted for 0.03% and 0.32% genipin in 1:1 DMSO:PBS and greater than a 6-log reduction is noted in the 0.63% genipin in 1:1 DMSO:PBS group (all statistically significant at p≦0.05).

FIG. 8a shows confirmatory experiment evaluating the sporicidal activity of 0.63%-10% genipin in 1:1 DMSO:PBS after 72 hours of treatment at room temperature (25° C.) with genipin. All genipin groups demonstrate at least 6-log reductions in spore viability (all statistically significant at p≦0.05).

FIG. 8b shows pooled data. Sporicidal effects of 0.63%-10% genipin in 1:1 DMSO: PBS compared to 10% formalin treated controls after 72 hours of treatment at room temperature (25° C.). All genipin groups demonstrate at least 6-log reductions in spore viability (all statistically significant at p≦0.001).

FIG. 9 shows sporicidal effects of 0.63%-10% genipin in 1:1 DMSO:PBS compared to no-genipin and 10% formalin-treated controls after 72 hours of treatment at room temperature (25° C.) (all treatments, p=0.01 versus controls).

FIG. 10 shows Scanning electron micrograph of B. subtilis on (a) an untreated spore strip, (b) spore strip exposed to 1:1 DMSO:PBS without genipin at room temperature (25° C.), (c) spore strip exposed to 0.63% genipin in 1:1 DMSO:PBS at room temperature (25° C.), and (d) spore strip exposed to 10% genipin in 1:1 DMSO:PBS at room temperature (25° C.).

FIG. 11 shows Sporicidal effects of 2.6 mg-42 mg genipin/106 spores in 1:1 DMSO: PBS compared to 10% formalin and untreated controls after 72 hours of treatment at room temperature (25° C.) for B. pumilus and G. stearothermophilus. All genipin groups demonstrate at least 6-log reductions in spore viability (p<0.001). Note the presence of spore viability in the formalin treated G. stearothermophilus group.

FIG. 12 shows the results of 0.63% genipin in various combinations of PBS/DMSO evaluated at room temperature (25° C.) and at 37° C. 2/5 sterile vials with 0.63% genipin in 50% DMSO/50% PBS at room temperature (RT), demonstrating at least a 5-log reduction (p<0.01). At all doses of DMSO (0-50%) sterilization of 5/5 vials with 0.63% genipin at 37° C. was observed, demonstrating at least a 6-log reduction (all p<0.01).

FIG. 13 contains Table 1. Table 1 shows the results of Mann-Whitney U tests comparing 15, 25, and 35 mL of 0.625% genipin in PBS at room temperature (25° C.). A grayed cell indicates a p-value >0.10. “mL” indicates volume of 0.625% genipin in PBS. Results are separated into red, green and blue groups.

FIG. 14 contains Table 2. Table 2 shows one-tailed MWU analysis showed yield strain trended greater in the 15 mL/0.625% genipin group compared to the control: “mL” indicates volume of 0.625% genipin in PBS. “All-Genipin” is formed from all genipin treated specimens.

FIG. 15 contains Table 3. Table 3 shows effects of genipin on mechanical properties of collagen tissues. Dose refers to dose of genipin used in the cited research.

### DETAILED DESCRIPTION OF THE INVENTION

### I. Introduction

The invention contemplates a method for sterilizing collagen-based hard and soft tissues, from animal and human donors or created synthetically. For example, the tissues could include, but not limited to bone, cartilage, tendon, ligament, collagen scaffolds, collagen substrates, tissue meshes, cornea, and heart valves. For example, these procedures would be performed after explant of the tissue from the host, or after being prepared in the laboratory, to sterilize the graft prior to utilization in surgical procedures. Additionally, genipin fixation sterilizes the tissues through crosslinking the organic framework of microbes while maintaining or enhancing mechanical strength of the tissue graft by stabilizing the collagen backbone with crosslinks. Grafts experience significant and repetitive loads during their duty cycle, sterilizing collagen-based hard and soft tissues without causing a loss in biomechanical properties is quite important.

In one embodiment, the invention contemplates a method for sterilizing collagen-based hard and soft tissues, from animal and human donors or created synthetically, including, but not limited to bone, cartilage, tendon, ligament, cornea, and heart valves. In one embodiment, these procedures would be performed after explant of the tissue from the host, or after being prepared in the laboratory, to sterilize the graft prior to utilization in surgical procedures. In one embodiment, genipin fixation sterilizes the tissues through crosslinking the organic framework of microbes while maintaining or enhancing mechanical strength of the tissue graft by stabilizing the collagen backbone with crosslinks bone allografts experience significant and repetitive loads during their duty cycle, sterilizing bone allografts without causing a loss in biomechanical properties is quite important. The current gold standard for sterilizing bone allografts is with gamma irradiation, a process that sterilizes the graphs while simultaneously damaging collagen molecules and destroying the intra and intermolecular collagen bonds, and consequently, weakening the graft. In one embodiment, chemical crosslinking presents two key advantages over gamma irradiation: 1) it negates bioburden by crosslinking the microbial organic matter, 2) it does not impair the strength of bone and it strengthens soft tissues. Common chemical crosslinking agents formaldehyde and glutaraldehyde are potent antimicrobial agents that strengthen collagen, but they are also cytotoxic. Genipin is a naturally-derived chemical crosslinking agent binding to amino or amine group branches to form its crosslinks. In one embodiment, it reduces inflammation, foreign body immunogenicity, and strengthens collagen, while being substantially less cytotoxic than formaldehyde and glutaraldehyde.

There is a growing body of research into genipin's role in increasing the tensile strength of collagen-based soft tissues when solubilized in phosphate-buffered saline (PBS), and into its anti-inflammatory/anti-immunogenic roles. Genipin has neither been studied as a sterilant, likely due to the limitations of studying it in PBS, in which its solubility is limited to approximately 1%, nor have its mechanical benefits on collagen-based tissues been investigated when dissolved in dimelhyl sulfuxide (DMSO) or on bone, under any conditions. In one embodiment, a genipin solution can be used to sterilize inert materials (polyethylene, metals, etc) that are dipped in genipin solution to crosslink whatever microbes, viruses, or other potential sources of contamination are on the surface thus sterilizing non-protein based materials.

In one embodiment, the effective range of genipin solution may be broadly from low concentrations, such as 0.01%, to solution saturation (as much as is dissolvable or until precipitates provided it's >0.63% in PBS). In one embodiment, the solution may be up to 75% genipin in DMSO. In one embodiment, the solution may not contain DMSO. In one embodiment, the solution may contain dimethylformamide. It is not intended that the present invention be limited by the nature of the solution used to dissolve genipin. Moreover, the present invention contemplates various solutions used continuously or changed at intervals during and after the treatment of tissues with genipin. It is not intended that the present invention be limited by the nature of the source of tissues crosslinked by the current invention. In one embodiment, the tissues are protein-based hard and soft tissues, from animal and human donors or created synthetically, including, but not limited to bone, cartilage, tendon, ligament, collagen scaffolds, tissue meshes, cornea, heart valves, skin, lab-based collagen or proteinaceous substrates (including drug delivery systems), and lab-created tissues. In one embodiment, the tissues are collagen-based hard and soft tissues, from animal and human donors or created synthetically, including, but not limited to bone, cartilage, tendon, ligament, collagen scaffolds, tissue meshes, cornea, and heart valves. Moreover, the present invention contemplates the combination of various tissue sources for genipin crosslinking sterilzation.

It is not intended that the present invention be limited by the nature of the source of genipin used for crosslinking. The present invention also contemplates the addition of other components (e.g., inert or bioactive) without affecting the methods of the present invention.

In one embodiment, the present invention contemplates crosslinking treatment of tissues at a range of temperatures. In one embodiment, the invention considers temperatures short of the denaturation temperatures for the given tissue. In one embodiment, the temperature of the solution can reach 100° C. In some embodiments, the invention contemplates treating the tissues with solution under an atmospheric pressure other than standard pressure. In some embodiments, the invention contemplates treating the tissues with solution under an atmospheric pressure other than standard pressure or room temperature. In some embodiments, the invention contemplates treating the tissues with solution under a pressurized atmosphere.

In one embodiment, the present invention contemplates post-treatment processing. In one embodiment, the invention involves treating said tissue with genipin in a DMSO:PBS solution, then subsequently treat (post-treatment) with a solution not containing genipin. In one embodiment, said subsequent treatment is 100% PBS or 90% ethanol. In one embodiment, said post-treatment further matures genipin crosslinks. In one embodiment, the invention contemplates exposure to genipin containing solutions and subsequent treatment with or without genipin wherein the solvents, exposure duration, temperature, and pressure may be varied. In one embodiment, the invention contemplates exposure to genipin containing solutions and subsequent treatment without genipin wherein the solvents, exposure duration, temperature, and pressure may be varied.

In one embodiment, the invention contemplates serially changing genipin containing solutions in the treatment of tissues. In one embodiment, the invention contemplates constant mixing or shaking of said solutions. In one embodiment, the invention contemplates preparation of genipin containing solutions in a cold environment to limit autopolymerization. In some embodiments, treatment of said tissues in a warm environment, such as room temperature (25° C.) or 37° C. Bone and soft tissue allografts experience significant and repetitive loads during their duty cycle, sterilizing collagen-based hard and soft tissues without causing a loss in biomechanical properties is quite important. In one embodiment, the current invention enhances resistance to fatigue failure, allowing it to endure more cycles of loading than even a native tissue. Grafts tend to be stronger than the native tissue because their properties deteriorate much faster (ie in ACL reconstruction). In one embodiment, genipin can be used to enhance an already sterilized graft's properties even when genipin is not primarily used as a sterilant. In one embodiment, genipin can be used to protect from damage gamma irradiated sterilized bone and soft tissues. In one embodiment, genipin can be used to repair damage induced by gamma irradiated sterilized bone and soft tissues while maintaining graft sterility. In one embodiment, genipin can be used to pre-treat grafts that are to be sterilized with gamma radiation, therefore reducing the pre-radiation bioburden thus permitting use of a lower radiation dose (which would decrease the amount of damage done by gamma radation).

One reference, Xi-xun, Y. et al. (2010) Journal of Materials Science. Materials in Medicine 21(2), 777-785 [15] describes the use of genipin was used to fix biological tissues. Biological vascular scaffolds were prepared through cell extraction and fixing the porcine thoracic arteries with 1% (by w/v) genipin solution for 3 days, and then examined their mechanical properties and microstructures; glutaraldehyde- and epoxy-fixed counterparts were used as controls.

Another reference, Bhrany, A. D. et al. (2008) J. Tissue Eng. Regen. Med. 2(6), 365-372 [16], describes a study to show that crosslinking with genipin improves the stability of the esophagus acellular matrix (EAM) while maintaining minimal biological reactivity and preserving EAM regeneration potential in a rat model. Genipin-crosslinked EAMs supported epithelial adhesion and proliferation while glutaraldehyde-crosslinked EAMs did not. Conditions for Genipin crosslinked EAM (Gp-EAM): 0.625% Genipin×14 h PBS rinse×24 h with changes every 6 hours. Another reference, Englert, C. et al. (2007), Arthritis Res. Ther. 9(3), R47 [17], describes genipin for tissue cross-linking Genipin was used at a concentration of 5 mg/ml in PBS. Another reference, Sung, H.-W. et al. (2003), Journal of Biomedical Materials Research Part A 64A(3), 427-438 [18]. This reference describes tissue fixation in genipin (Genipin (0.03M), buffered with PBS (phosphate-buffered saline, pH 7.4)).

Another reference, Lima, E. G. et al. (2009), Journal of Biomedical Materials Research Part A 91A(3), 692-700 [19]. This reference describes the use of genipin as a medium supplement to promote cross-linking of de novo cell products as they are produced. Exposure ranged from 0, 22, 220, 2200 μMolar of sterile genipin (Sigma-Aldrich) for 7 days for various tissues and 0 μM, 22 μM, or 220 μM genipin continuously throughout the 42 day culture period. The reference describes complete cell death at the 2200 μMolar of sterile genipin. Another reference, Sung, H.-w. and Liang, H.-c. “Acellular Biological Material Chemically Treated with Genipin,” U.S. Pat. No. 6,545,042 (Published Apr. 8, 2003) [20]. This reference describes acellular biological materials, which among other things, has been fixed with genipin. Another reference, Sung, H.-w. et al. “Acellular Biological Material Chemically Treated with Genipin,” U.S. Pat. No. 6,998,418 (Published Feb. 14, 2006) [21]. This reference describes acellular biological materials, which among other things, has been fixed with genipin. Another reference, Lin, C.-k. et al. “Chemical Modification of Biomedical Materials with Genipin,” U.S. Pat. No. 6,608,040 (Published Aug. 19, 2003) [22]. This reference describes the use of a 5% solution of genipin in 0.01 M phosphate buffered saline (pH 7.4) for crosslinking collagenous tissues, subsequently, the fixed tissue was sterilized with a 70% ethanol solution for 7 days at 37° C. Another reference, Chen, C.-N. et al. (2002), J. Biomed. Mater. Res. 61(3), 360-369 [23]. This reference describes investigation of reuterin for sterilizing and crosslinking biological tissues. Reuterin is a multi-compound dynamic equilibrium (HPA system, HPA) consisting of 3-hydroxypropionaldehyde, its hydrate, and its dimer. The results obtained in the minimal inhibitory concentration and minimal bactericidal concentration studies and in the sterilization study of a contaminated tissue indicated that the antimicrobial activity of reuterin is significantly superior to its glutaraldehyde counterpart. Additionally, it was found that reuterin is an effective crosslinking agent for biological tissue fixation. The reuterin-fixed tissue had comparable free amino group content, denaturation temperature, and resistance against enzymatic degradation as the glutaraldehyde-fixed tissue. The results indicate that reuterin is an effective agent in the sterilization and fixation of biological tissues.

Another reference, Santos, N. C. et al. (2003), Biochem. Pharmacol. 65, 1035-1041 [24]. This reference describes DMSO as one of the most common solvents for the in vivo administration of several water-insoluble substances. Despite being frequently used as a solvent in biological studies and as a vehicle for drug therapy, the side effects of DMSO (undesirable for these purposes) are apparent from its utilization in the laboratory (both in vivo and in vitro) and in clinical settings. This reference serves as an example that DMSO is a well-known polar aprotic solvent used to dissolve water-insoluble agents and introduce them into biological systems or tissues.

Nearly one million bone and soft tissue allografts are transplanted annually for musculoskeletal reconstruction (American Association of Tissue Banks, unpublished report). Bone graft is commonly used in dental [25, 26], maxillofacial [27-29], craniofacial [29-32], and orthopaedic procedures [33-35]. While autograft is the gold standard for bone grafting [36], allograft is sometimes advantageous as there is shorter associated operative time, no donor site morbidity, and no size or quantity limitations [35, 37]. However, allografts can elicit host immune responses and carry the risk of transmitting human immunodeficiency virus, hepatitis B virus, and hepatitis C virus [37-43].

Many measures are taken to reduce the incidence of allograft-associated disease transmission. These include donor screening procedures; rigid processing, preservation, and storage techniques; and patient tracking post-transplant to monitor outcomes [40, 44, 45]. Stringent technique and protocol cannot prevent all disease transmission, and therefore, terminal sterilization by gamma radiation is often essential to minimize risk of infection.

Terminal sterilization with gamma radiation is used to achieve sterility, reducing viral and bacterial loads [46-48]. But while gamma radiation is antimicrobial, it also causes scission of the collagen peptide backbone [49-51] and reduces the concentration of intermolecular crosslinks [52, 53]. In compression and bending tests, radiation has been shown to decrease bone strength by 10-36% [54-56].

Chemically crosslinking collagen may prevent or restore radiation-induced bone embrittlement. Genipin is a safe, naturally occurring crosslinking agent [1, 57]. Crosslinking by genipin has demonstrated efficacy increasing biomechanical properties of porcine pericardia [18], porcine cornea [58], rat lumbar and caudal motion segments [59], and sheep tendon [60].

Genipin may have additional effects on terminal sterilization as the antiseptic properties of crosslinking agents are well known. Formaldehyde and glutaraldehyde are bactericidal, sporicidal, virucidal, and fungicidal [61, 62]. Geniposide and genipin have been shown to have anti-fungal properties [63], and a genipin-derivative was shown to have anti-hepatitis B virus activity [64]. From what can be determined, the effects of genipin on mechanical properties of bone have not been studied before. Furthermore, effects of genipin on bioburden introduced by bacterial spores are unknown. As a safe crosslinking agent, genipin theoretically possesses an important role as an adjuvant to the terminal sterilization process. In one embodiment of the invention chemical crosslinking by genipin will strengthen bone while reducing the bioburden of the processed allograft.

Nearly 1.5 million bone and soft tissue allografts are transplanted annually for musculoskeletal reconstruction [65]. Allografts are advantageous due to no donor site morbidity, shorter operative time, and not being limited by the size and quantity of available graft [35, 37, 66, 67]. However, they are antigenic and lack sterility [37-43, 67, 68], including risk of transmitting the human immunodeficiency virus, hepatitis B virus, and hepatitis C virus [40, 42, 43, 67].

Terminal sterilization with gamma radiation is commonly employed for achieving sterility of musculoskeletal allografts with demonstrated efficacy in reducing viral and bacterial loads [46-48, 67]. However, while gamma radiation is antimicrobial, it also causes scission of the collagen peptide backbone [50, 51] and reduces the concentration of intermolecular crosslinks [52, 53] in tendon and bone. This leads to a significant impairment in soft tissue tensile strength [69, 70], bone bending strength [54, 55], and ultimately, clinically relevant graft failure [7-74]. Thus, the finding an alternative sterilization method that does not impair allograft mechanical properties is of importance.

Chemical crosslinking is an established method for negating bioburden and strengthening collagen. Formaldehyde and glutaraldehyde are bactericidal, sporicidal, virucidal, and fungicidal [61, 62]; they strengthen collagen [18, 75, 76], but are also cytotoxic [1, 77-79]. Genipin is a naturally occurring crosslinking agent that potentially possesses the sterilizing and collagen-strengthening advantages of formaldehyde and glutaraldehyde, while also being safe. Genipin is obtainable from the fruits of Gardenia jasminoides Ellis [57, 80], and was found to be 10,000× less cytotoxic than glutaraldehyde [1]. It reacts with amino groups within or between adjacent collagen molecules to form intra- and inter-helical crosslinks. Polymerization of genipin may also permit inter-microfibrillar crosslinking [18]. There is a paucity of studies on the antimicrobial effects of genipin, but geniposide and genipin have been shown to have anti-fungal properties [63] and a genipin-derivative was shown to have anti-hepatitis B virus activity [64]. Genipin has been shown to increase tensile strength in porcine, rat, and sheep soft tissue models [58, 60, 81]; studies investigating the effects of genipin-treatment on bone mechanical properties are not currently known.

The role of genipin as a sterilant has not been the focus of studies. To investigate this further, a genipin solution was created with which demonstration of genipin's efficacy in eradicating Bacillus subtilis var niger bacterial spores would be determined. Attention was initially focused on B. subtilis as this is one of the two spores used in establishing a liquid sterilization process per the World Health Organization [82], and it has been studied before in this context by the US Food and Drug Administration [83]. After completing a series of experiments on B. subtilis, evidence demonstrating genipin's efficacy in sterilizing other spore species, including B. pumilus and Geobacillus stearothermophilus, the biological indicators used in evaluating gamma radiation (B. pumilus), steam sterilization (G. stearothermophilus), and low temperature steam formaldehyde sterilization (G. stearothermophilus). Although it is not necessary to understand the mechanism of an invention, it is believed that, much like formaldehyde and glutaraldehyde, genipin will sterilize the treated substrates. In one embodiment, the invention contemplates a genipin alternative for sterilizing biomaterials in which maintenance of mechanical strength is valued.

### II. The Effects of Genipin Crosslinking on the Biomechanics of Bovine Cortical Bone and Reducing Bacterial Bioburden

### EXPERIMENTAL

### Example 1

### Bone Penetration by Genipin, Part I

To determine how well genipin penetrates cortical bone, a bovine femoral diaphysis was obtained from the local butcher. A Biro 11 Retail Meat Saw (Biro Manufacturing Company, Marblehead, Ohio, USA) was used to cut the femoral diaphysis into halves. The proximal half was then cut into thirds; the anteromedial third was further bisected longitudinally and one of the two longitudinal segments was used in this research. An Ecomet 6 Variable Speed Grinder-Polisher (Buehler, Lake Bluff, Ill., USA) was used first with Beuhler CarbiMet 2 special silicon carbide grinding paper Grit 240/P280 to flatten and smooth the periosteal and endosteal surfaces to a final width of 4.5-5.0 mm. This was further polished using Grit 400/P800 grinding paper. An Isomet 1000 Precision Sectioning Saw and Series 15 HC Diamond (Buehler, Lake Bluff, Ill., USA) wafering blade were used to make slices 1.4-1.6 mm thick and 10 mm long; thin slices were initially cut since it only superficial genipin penetration of the 0.400 mm depth of ELAC was observed. A total of 14 specimens were cut. Specimens were wrapped in phosphate-buffered saline (PBS) (Fisher Scientific, Pittsburgh, Pa., USA) soaked Kimwipes and frozen at −20° C. for storage during intermediate steps.

Seven specimens were treated with 0.625% genipin (Wako Chemicals USA, Inc., Richmond, Va., USA) solution in PBS and seven specimens were treated with a 0.625% genipin in 90% ethanol (diluted from 200 proof ethanol, Decon Labs, King of Prussia, Pa., USA). Specimens were randomly assigned to groups for treatment durations of 72 hours (N=3) and one week (N=4) with 25 mL of solution.

Genipin crosslinking creates a blue pigment [57]. At each time point, the specimens devoted to that cohort were removed from their treatment solutions and cut in half to view the depth of color change, which was used as a surrogate measure of crosslinking. Bone specimens were viewed with a Leica MZ6 stereomicroscope (Leica Microsystems, Buffalo Grove, Ill., USA) at 2.0-2.5× magnification using a 150 dots per inch printout to measure penetration.

Results:

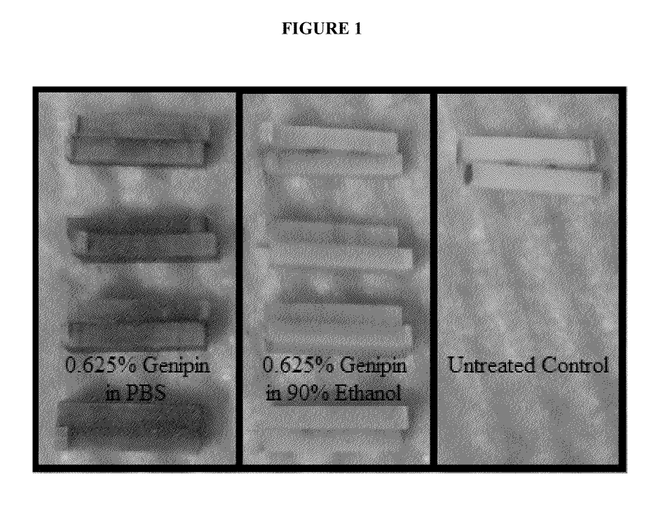

A total of 14 specimens were evaluated in the preliminary determination of genipin's ability to penetrate bone. At 72 hours two patterns of genipin penetration were noted. In the 0.625% genipin in PBS group, genipin pigment was dark blue-green around the periphery of the specimen to a depth of 0.65±0.06 mm (87.0±11.6% of specimen thickness); lighter blue-green pigment was notable centrally, fully penetrating the depth of all bone specimens, 0.75±0.02 mm. In the 0.625% genipin in 90% ethanol group, a homogenous, very light green was noted to fully penetrate the bone specimens to 0.76±0.04 mm. At one week, 0.625% genipin in PBS again exhibit a two-colored pigmentation pattern with darker penetration to 0.64±0.04 mm (82.8±5.3%) and full penetration with light blue-green pigment to 0.77±0.01 mm. For 0.625% genipin in 90% ethanol, penetration was 0.74±0.02 mm (99.3±1.4%) deep (FIG. 1). At one week, analysis using the darker pigmentation only for genipin in PBS suggested less penetration than the ethanol group (p=0.03); but there was no difference when analyzing based on total depth of color change at either time point.

### Example 2

### Bone Penetration by Genipin, Part II

After determining that 0.625% genipin in PBS and 90% ethanol fully penetrated 1.5 mm thick slices of bovine femoral cortex (see Results) the goal was set to determine how deep genipin can penetrate using thicker samples. Bovine femoral cortical bone from the proximal meta-diaphyseal region were stripped of periosteum and soft tissue from the periosteal surface and bone marrow and the majority of trabecular bone from the endosteal surface. The length and width of the specimen were cut such that radial cortical thickness would be the narrowest dimension. Using methods described in Part I, specimens were cut to 14.8 mm long×12.2-12.7 mm wide. Since genipin is more soluble in ethanol than in PBS (Genipin Product Information, Cayman Chemical, Ann Arbor, Mich., USA), one specimen was placed in a 25 mL solution of 0.625% genipin in PBS and one specimen was placed in 2.0% genipin in 90% ethanol. Bones were treated for one week after which time they were cut in half and penetration depth was measured.

Results:

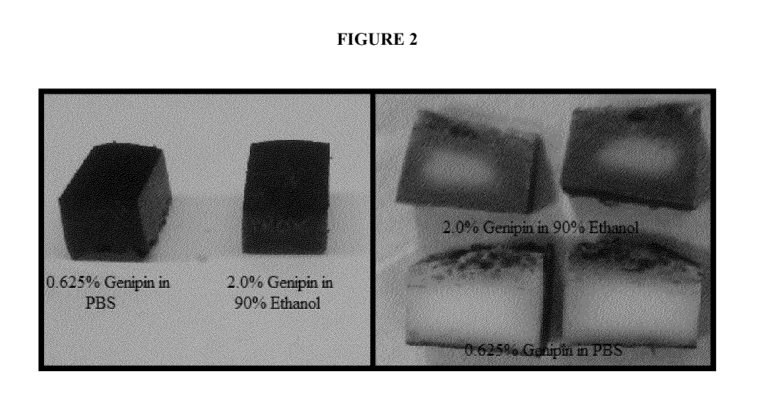

One sample was treated with either 0.625% genipin in PBS or 2.0% genipin in 90% ethanol. After 24 hours of treatment, both demonstrated color changes on exposed cortical surfaces. After one week, the shells of specimens were dark blue-green. Just deep to the shell of the 0.625% genipin/PBS specimen was a brown layer, deep to which bone was at baseline white. The shell of the 2.0% genipin/90% ethanol specimen extended deeper than the 0.625% genipin/PBS specimen and the core was brown; there was no visible white color (FIG. 2).

### Example 3

### Genipin Mass: Volume Effect on Bone Color Change

To assess whether sufficient genipin is provided at the mass: volume ratios was employed, the effects of varying the genipin mass:bone volume ratio on color change was measured. The second anteromedial segment cut in Part I of the bone penetration pilot research study was used here. The bone segment was polished and sliced similarly to create 12 specimens with average dimensions of approximately 37.4 mm×2.7 mm×0.5 mm. A total of 12 segments were cut (N=3 per group).

A 0.625% genipin in PBS solution was prepared because the bovine specimen demonstrated more intense color changes at that concentration in PBS versus in 90% ethanol. In Part I of the bone penetration study the ratio of genipin in PBS to bone volume was 1 mL (6.25 mg genipin): 5.4-9.0 mm³. Genipin solution volumes were calculated to approximate these upper and lower volume ratios; in this research 15 mL, 25 mL, and 35 mL of 0.625% genipin in PBS were used. A 25 mL PBS group without genipin served as a control.

Bone specimen color change was assessed using a Hewlett-Packard 5300C (Hewlett-Packard Company, Palo Alto, Calif., USA) flatbed scanner. A printout with color samples was scanned with the bones to serve as a control for the repeated scans. Scans were saved at 150 dpi (the highest resolution of the scanner) and analyzed using ImageJ (National Institutes of Health, Bethesda, Md., USA). Eight-bit color histograms breaking specimen color into red, green, and blue components were created for each bone sample and each of the color controls. This provides a numeric intensity value for each color on a scale from 0 to 255 for which 0, 0, 0 (red, green, blue) is black; 255, 255, 255 is white; 255, 0, 0 is red; 0, 255, 0 is green; and 0, 0, 255 is blue. The mean color value of each bone specimen was used for analysis. Bones were scanned after treatment for 24 hours, 72 hours, and one week.

Results:

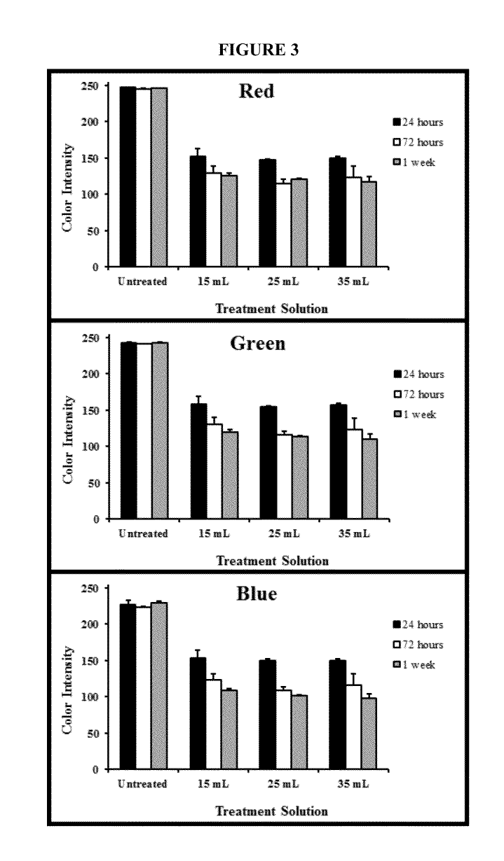

Bone specimen color was evaluated after 24 hours, 72 hours, and one week of treatment with 0.625% genipin in PBS (FIG. 3). MWU tests were performed, and all of the time points evaluated, the untreated controls were significantly lighter (red, green, and blue) than all treatment groups (for all comparisons p=0.04). Overall, bones treated with genipin became pigmented darker with respect to all colors with increasing time and increasing volume of genipin solution (FIG. 3 and Table 1).

### Example 4

### Genipin Effect on Bone Strength

The specimens that were treated with 0.625% genipin in PBS in the color change pilot research study were used to get preliminary data on (1) the effect of genipin on bone strength and (2) the relationship of color intensity on bone strength. All specimens had been treated for one week before testing. Specimens with a width >11% from the average width were excluded from data analysis. Monotonic three-point bending tests were performed with a TestResources 100R Universal Tester (TestResources, Inc., Shakopee, Minn., USA). The support span was 20 mm. A TestResources 10 lb load cell and MTestwR v1.4.2 software were used for data acquisition. A custom Microsoft Excel macro was used to determine yield stress, yield strain, resilience, bending modulus, maximum flexural strength, and flexural rigidity [84]. Data analysis was performed by comparing all groups individually and by comparing all the genipin-treated specimens together (“all-genipin”) against the control group.

Results:

Specimens used to determine the effects of time and genipin mass on color change were further evaluated for their mechanical properties. All specimens had been treated with either PBS or a 0.625% genipin solution for one week. Two-sample T-tests confirmed no statistically significant differences or trends in specimen dimensions.

With groups in this pilot research of N=2 or 3 a more liberal standard for trend was used, p<0.15. As noted in Table 2, one-tailed MWU analysis showed yield strain trended greater in the 15 mL/0.625% genipin group compared to the control (1.36%±0.15% vs. 1.21±0.00%, p=0.12), bending modulus trended greater in the 25 mL/0.625% genipin group compared to the control (26.7±2.2 GPa vs. 21.8±2.5 GPa, p=0.08) and compared to the 15 mL/0.625% genipin group (26.7±2.2 GPa vs. 19.2±2.2 GPa, p=0.08), and maximum flexural strength trended greater in the 25 mL/0.625% genipin group compared to the 15 mL/0.625% genipin group (346.9±42.3 MPa vs. 293.0±20.3 MPa, p=0.08).

### Example 5

### Qualitative Antibacterial Effects of Genipin

The antibacterial effects of genipin solutions on Bacillus atrophaeus spores was assessed. Using aseptic technique, B. atrophaeus mini spore strips (N=4 per group) with 1.2×10⁶ spores per strip (North American Science Associates, Inc., Northwood, Ohio, USA) were either untreated, or treated with either 1 mL PBS, 0.625% genipin in PBS (1.4×10¹³ genipin molecules per spore), 90% ethanol, 10% genipin in 90% ethanol (2.2×10¹⁴ genipin molecules per spore), or 10% formalin for one week. Ten percent genipin was used in 90% ethanol for direct comparison to 10% formalin. Solutions were passed through a 0.2 μm Whatman filter (Fisher Scientific, Pittsburgh, Pa., USA) prior to being used to remove extraneous bacteria.

After treating the spore strips for one week they were transferred to Releasat® rapid-readout color changing vials (SGM Biotech, Bozeman, Mont., USA). Releasat® vials have specially formulated soybean-casein digest medium and a pH indicator designed to change color from orange to yellow in the presence of B. atrophaeus growth within 72 hours or remain orange if the spore strips are sterile. The spore strips treated with 10% genipin in 90% ethanol were removed from their respective medium vials and washed in 10 mL of sterile 90% ethanol for 15 minutes after it was noticed that within 90 minutes of placement into the Releasat® medium that the color changed from orange to brown (genipin-induced color change). These spore strips were placed in new Releasat® vials after washing. Spores were incubated at 37° C. and vials were checked after 24, 48, and 72 hours for color change and assessments of turbidity.

Statistical Analysis:

Mann-Whitney U (MWU) tests were performed with Minitab 14 (Minitab, Inc., State College, Pa., USA) for non-parametric data analysis of independent treatment groups. For penetration analysis, the percent penetration was used (with respect to half the bone thickness since solutions penetrated through all surfaces) and two-tailed tests since the concentrations of genipin used were equivalent in both solvents. For color analysis, it was hypothesized that duration of treatment and amount of genipin used to treat bone would lead to darker pigmentation and one-tailed tests were performed in these cases; two-tailed tests were performed in all other situations. For mechanical tests, it was hypothesized increasing quantities of genipin would better improve mechanical properties and one-tailed statistics were performed. Unless otherwise specified, p<0.05 was used for statistical significance and p<0.10 was used to define a trend.

Results:

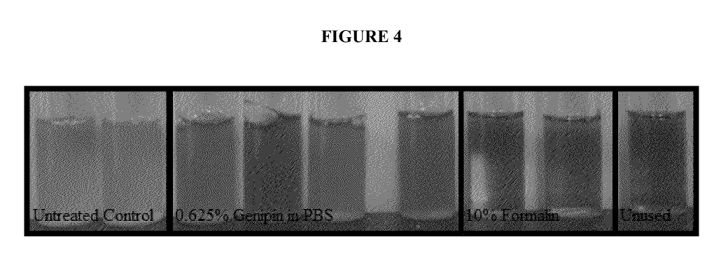

B. atrophaeus spore strips with 1.2×106 spores were either untreated, or treated with PBS, 0.625% genipin in PBS, 90% ethanol, 10% genipin in 90% ethanol, or 10% formalin. After 72 hours, the color of the medium containing formalin-treated spore strips remained orange (baseline, indicating sterility). The medium of all other groups had changed to yellow within 24 hours of inserting the spore strips (FIG. 4). The medium containing spores strips treated with 0.625% genipin in PBS appeared less turbid than the PBS and untreated control at all time points; 10% genipin in 90% ethanol appeared less turbid than the 90% ethanol and untreated control after 24 and 48 hours only and are grossly similar after 72 hours.

### Discussion

Bone graft is commonly used in musculoskeletal reconstruction procedures [33-35]. Its uses include, but are not limited to, repair and reconstruction of congenital and acquired bony deformities, fractures, non-unions, tumor defects, augmentation procedures, and fusions [25-36]. Due to its efficacy and convenience, terminal sterilization by gamma radiation is often essential to minimize risk of disease transmission and infection [46-48]. However, impairment in the mechanical properties of bone secondary to gamma radiation sterilization is a major concern and Hernigou et al. found this translated into a 6% fracture rate and 5.5% non-union rate in massive allografts irradiated at 25 kGy by a minimum of three-year follow-up [71]; Lietman et al. found a 38% fracture rate in massive, irradiated allografts (10 kGy to 30 kGy) compared to 18% in non-irradiated controls [73].

Genipin is a naturally occurring crosslinking agent obtainable from its parent geniposide from the fruits of Gardenia jasminoides Ellis [57, 80], or it may be prepared synthetically [85]. Genipin was found to be 10,000× less cytotoxic than glutaraldehyde and the proliferative capacity of fibroblasts exposed to the two compounds was 5,000× greater with genipin [1]. Sung et al. proposed that genipin reacts with amino groups within or between adjacent collagen molecules to form intra- and inter-helical crosslinks. Polymerization of genipin may also permit inter-microfibrillar crosslinking [18]. Tensile tests have shown genipin increases the strength of many soft collagen-based tissues (Table 3).

The current analysis took a preliminary look at the effects of genipin on bone. In both PBS and 90% ethanol, genipin fully penetrated 1.5 mm slices of cortical bone, and at this concentration, genipin may better crosslink bone in PBS than 90% ethanol as suggested by darker blue-green color change. Since this approached the maximal concentration of genipin dissolvable in PBS, 90% ethanol was used to dissolve a greater concentration of genipin. It was found that after one week, bone treated with 2.0% genipin in 90% ethanol had a more extensively, maturely crosslinked shell than bone treated with 0.625% genipin in PBS and it had brown pigment deep to the core, indicative of intermediately-staged crosslinks [86]; this was not appreciated in bone treated with 0.625% genipin in PBS. The bone shell when treated with 2.0% genipin in 90% ethanol (Penetration, Part II) was also darker blue-green than when treated with 0.625% genipin in 90% ethanol (Penetration, Part I). This suggests that mature crosslinks can be achieved in full-thickness cortical segments by possibly increasing the genipin concentration or duration of treatment, manipulating the solvent, periodically replacing the genipin solution, or by chemically or physically facilitating the ability of the solution to reach deeper bone, mechanisms warrant further investigation.

The color pilot data suggests that genipin crosslinking occurs in a time-dependent and mass-dependent fashion, and the trends noted from the mechanics data suggest that there may be a relationship between genipin mass, bone volume, and improvement in bone mechanics. Given the sample size of the groups, it is difficult to draw any conclusions, but compared to the controls, 15 mL/0.625% genipin in PBS demonstrated increased yield strain. The data also suggest an optimal mass:volume ratio as the modulus for the 25 mL/0.625% genipin group was greater than both the untreated control and 15 mL/0.625% genipin group, while the modulus of the 35 mL/0.625% genipin group was not greater than any other comparison group; maximum flexural strength was also greater in the 25 mL/0.625% genipin group versus the 15 mL/0.625% genipin group. This suggests that degree of color change is not necessarily correlated with mechanical improvement. However, as with all the pilot data presented, tentative conclusions can be drawn as the variability secondary to small sample sizes is likely influential.

Consistent with this data, other studies have demonstrated a time-dependent genipin effect [18]; using ELACs, Uquillas et al. demonstrated the effects of genipin to be time- and dose-dependent (Unpublished data). The dose-dependent effects of genipin on modulus and stress were noted from 0-6.0% concentrations; strain was enhanced from 0-2.0%. He also showed that, at equivalent genipin concentrations, the stress and modulus in genipin-treated ELACs were most improved when dissolved in 90% ethanol, intermediately in 80% ethanol, and marginally in PBS (Unpublished data).

There is a paucity of studies on the antimicrobial effects of genipin. Genipin and genipin-derivatives have been shown to have anti-fungal and anti-viral activity [63, 64]; genipin also induced resistance to bacterial collagenase from Clostridium histolyticum and pronase from Streptomyces griseus [18]. In pilot studies using B. atrophaeus spore strips it was shown that treatment of the spore strips for one week with 0.625% genipin in PBS and 10% genipin in 90% ethanol may decrease bacterial viability.

The obvious major limitation to the above studies is sample size. As all of the above data comes from pilot work, with resulting data intended to guide future research. Future research should involve more treatment durations, more genipin doses, different solvents, and of particular relevance, studying the effects of genipin on radiated bone to determine the possible role for genipin in preventing or restoring radiation-induced embrittlement. Quantitatively assessing the antibacterial effects of genipin is also necessary, and a log-reduction assays is required to accomplish this. Evaluating crosslinking microscopically will also be useful in evaluating genipin's molecular effects.

Nevertheless, preliminary research demonstrates that genipin may improve bone biomechanical properties and may possess antibacterial properties. These effects need to be further investigated. There remains the possibility that genipin may be a particularly beneficial agent as an adjuvant in the terminal sterilization process of cortical bone allografts.

### III. Genipin Sterilization: A Potential Alternative for Musculoskeletal Allograft Sterilization

### EXPERIMENTAL

As the sporicidal properties of genipin were previously unknown, genipin had to first be established as a sterilant at high doses against Bacillus subtilis var. niger. After confirming high-dose sterilization, a low-dose genipin sterilization was followed to find the lowest sterilizing dose. The sterilizing potential of high-dose and low-dose genipin is demonstrated by the absence of germination and proliferation in soybean-casein medium and by population assays. Broader spectrum sporicidal efficacy of genipin was established against B. pumilus and G. stearothermophilus. Genipin, 98% purity, was obtained from Wako Chemicals (Wako Chemicals USA, Inc., Richmond, Va.) and Challenge Bioproducts (Challenge Bioproducts Co. Ltd., Yun-Lin Hsien, Taiwan); head-to-head studies on their sporicidal activity was conducted which demonstrated equivalent efficacy in eradicating spore populations.

### Example 6

### High-Dose Genipin Sterilization of Bacillus subtilis Var. Niger

The sterilization potential of genipin was measured by treating B. subtilis mini spore strips with 1.2×10⁶ bacterial spores (ATCC 9372, North American Science Associates, Inc., Northwood, Ohio) with 0.5 mL of sterile 1:1 dimethyl sulfoxide (Avantor Performance Materials, Inc., Center Valley, Pa.): phosphate-buffered saline (Fisher Scientific, Pittsburgh, Pa.) (DMSO: PBS, v/v); 2%, 6%, and 10% genipin in 1:1 DMSO:PBS; and 10% formalin (Fisher Scientific, Pittsburgh, Pa.) (N=4 per group). Genipin treatments corresponded to 8.3 mg, 25 mg, and 42 mg genipin per 10⁶ spores for the 2%, 6%, and 10% groups, respectively. Treatment was conducted at room temperature, 20-25° C., for 24 hours and 72 hours. Spore strips were subsequently washed with sterile water and aseptically transferred to Releasat® rapid-readout color changing vials (SGM Biotech, Bozeman, Mont.) which have soybean-casein digest medium with the pH indicator phenol red, designed to change color from orange to yellow in the presence of spore germination and proliferation. Spores were incubated for one week at 37° C.

Results:

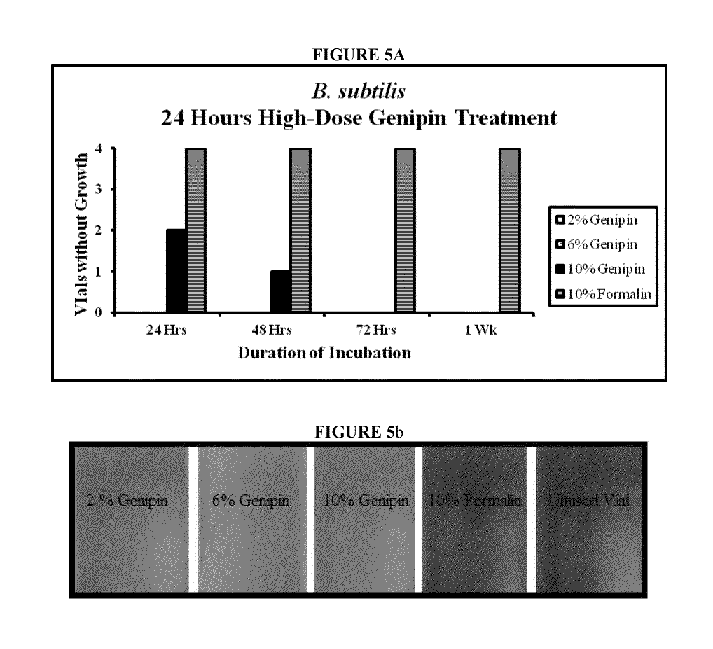

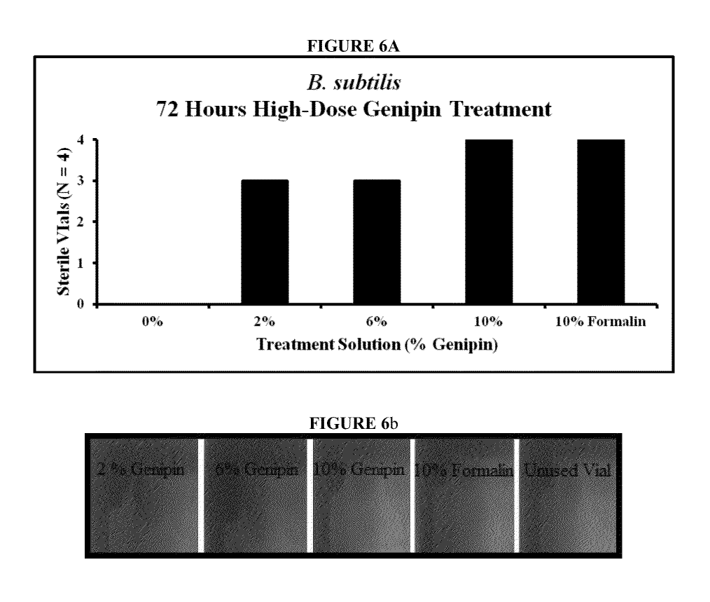

Treatment of B. subtilis spore strips with high-dose genipin led to time-dependent and dose-dependent effects on spore viability. After 24 hours of treatment, all spore strips treated with 2%-10% genipin demonstrated bacterial viability as evidenced by turbidity and color change in growth medium (FIG. 5a and FIG. 5b). However, longer incubation was required for turbidity to be seen from spore strips treated with 10% genipin compared to 2% and 6%. After 72 hours of treatment, 3 of 4 spore strips treated with 2% and 6% genipin and all spore strips treated with 10% genipin were sterilized (FIG. 6a and FIG. 6b). Assuming a 6-log reduction, 24.7-30.1% was expected sterile spore strips based on the manufacturer's COA (30.1%) and the current data PA (24.7%); thus, after 72 hours of genipin treatment, at least a 6-log spore reduction at all treatment levels was observed (2% and 6% genipin, chi square p=0.02-0.05, 95% one-sided CI=0.25 (statistically significant vs. PA); 10% genipin, chi square p<0.001-0.002; one-sided 99% CI=0.32).

### Example 7

### Low-Dose Genipin Sterilization of B. Subtilis Var. Niger

B. subtilis mini spores strips with 1.2×10⁶ spores were treated with 0.5 mL of sterile PBS and 1:1 DMSO:PBS without genipin; 0.03%, 0.32%, and 0.63% genipin in 1:1 DMSO: PBS; 0.63% genipin in PBS; and 10% formalin for 72 hours at room temperature (N=4 per group). Genipin treatments corresponded to 0.13 mg, 1.3 mg, and 2.6 mg genipin per 10⁶ spores for the 0.03%, 0.32%, and 0.63% groups, respectively. Spore strips were subsequently washed with sterile water, aseptically transferred to Releasat® vials, and incubated for one week at 37° C.

Results:

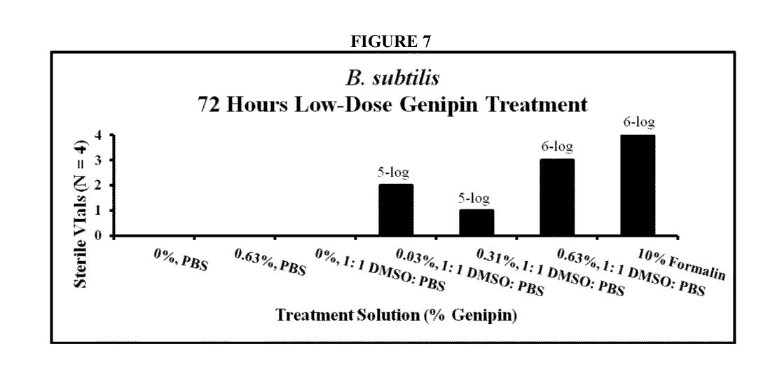

Treatment of B. subtilis spore strips with low-dose genipin led to solvent- and dose-dependent effects on spore viability (FIG. 7). All spore strips treated with PBS, 1:1 DMSO:PBS, and 0.63% genipin in PBS demonstrated viability. In contrast, two of four spore strips treated with 0.03% genipin in 1:1 DMSO:PBS were sterile and one of four spore strips treated with 0.32% genipin in 1:1 DMSO:PBS was sterile. Assuming a 5-log reduction, between 0.0006% (PA) and 0.00008% (COA) sterile vials was expected, thus a 5- to 6-log reduction in spore viability at 0.03% and 0.32% genipin (0.03% genipin was achieved, chi square p<0.001 (vs. COA and PA), 99% one-sided CI=0.04; 0.32% genipin, chi square p<0.001 (vs. COA and PA), 99% one-sided CI=0.003). Three of four spore strips treated with 0.63% genipin in 1:1 DMSO:PBS were sterile, consistent with at least a 6-log reduction in spore viability (chi square p=0.02-0.05, 95% one-sided CI=0.25 (statistically significant vs. PA)).

### Example 8

### Confirmation of B. Subtilis Var. Niger Genipin Sterilization

B. subtilis mini spores strips with 1.2×10⁶ spores were treated with 0.5 mL of sterile 1:1 DMSO:PBS without genipin; 0.63%, 2%, 6%, and 10% genipin in 1:1 DMSO:PBS; and 10% formalin for 72 hours at room temperature (N=4 per group). Spore strips were subsequently washed with sterile water, aseptically transferred to Releasat® vials, and incubated for one week at 37° C.

Results:

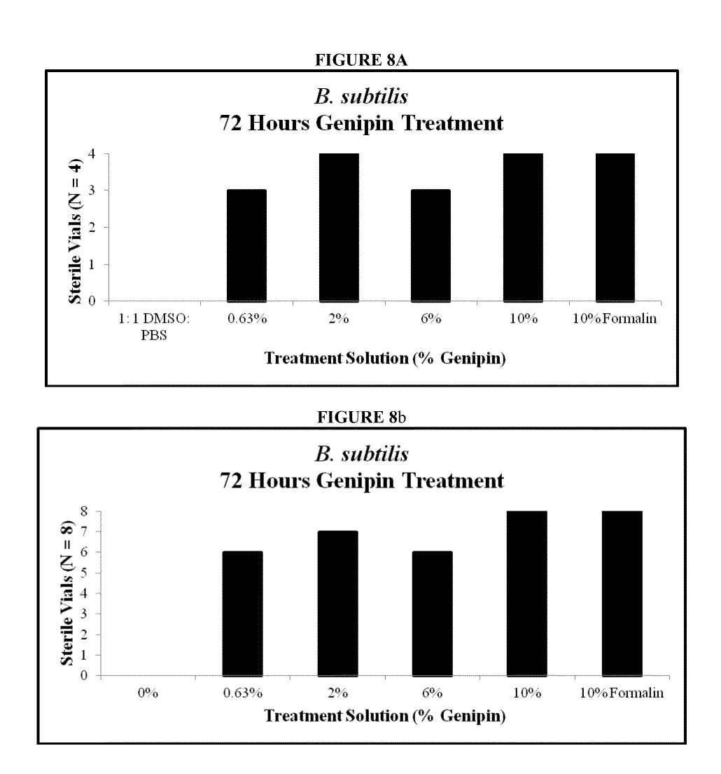

The B. subtilis sterilizing-dose experiments was repeated. After 72 hours of treatment, all genipin doses again sterilized the spore strips (FIG. 8a). Pooling the data with the “high-dose” and “low-dose” experiments established at least a 6-log reduction for 0.63%-10% genipin (0.63% and 6%, chi square p=0.001-0.006, 95% one-sided=CI 0.40 (statistically significant vs. COA and PA), 99% one-side CI=0.29 (statistically significant vs, PA); 2%, chi square p<0.001 (vs. COA and PA), 99% one-sided CI 0.41; 10%, chi square p<0.001 (vs. COA and PA), 99% one-sided CI=0.56) (FIG. 8b).

### Example 9

### B. Subtilis Var. Niger Population Assays

Sporicidal efficacy of genipin was confirmed with population assays. B. subtilis mini spores strips with 1.2×10⁶ spores were treated with 0.5 mL of sterile PBS; 1:1 DMSO:PBS without genipin; 0.63%, 2%, 6%, and 10% genipin in 1:1 DMSO:PBS; and 10% formalin for 72 hours at room temperature (N=4 per group). Spore strips were then washed with sterile water and then aseptically macerated, serially diluted, and plated onto petri dishes with soybean-casein digest agar (Mo Bio Laboratories, Carlsbad, Calif.). Spores were incubated for 48 hours at 32.5° C. after which time colony counts were performed.

Results:

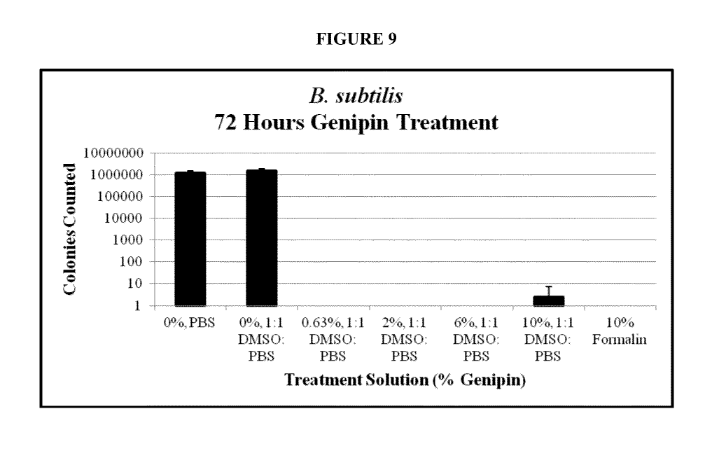

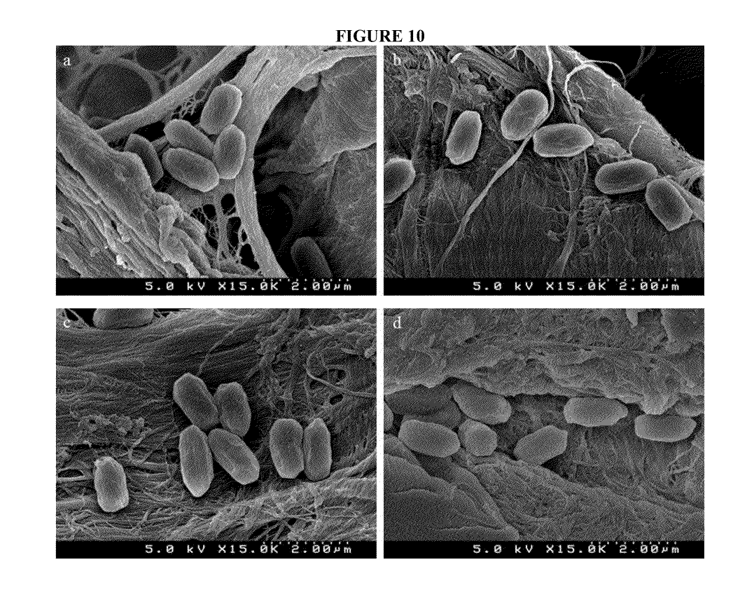

Population assays of B. subtilis using sterilizing-dose genipin treatment confirmed the results of the initial tests (FIG. 9). Treatment with PBS and 1:1 DMSO:PBS yielded the expected number of colonies from the spore strips (PBS=1.2×10⁶±2.7×10⁵, 1:1 DMSO: PBS=1.6×10⁶±3.5×10⁵) [87]. At the 1-log reduction level, all 0.63%, 2%, and 6% genipin-treated spore strips yielded no colonies and three 10% genipin-treated spore strips yielded no colonies (one plate had one colony) (all p=0.01 compared to both no-genipin control groups). All formalin treated spore strips grew no colonies at the 1-log reduction level.

### Example 10

### Microscopic Evaluation of Genipin-Treated B. Subtilis

The morphology of B. subtilis was evaluated using scanning electron microscopy. Spore strips were either untreated, treated with 0.5 mL of sterile 1:1 DMSO:PBS without genipin, or 0.5 mL of sterile 0.63% or 10% genipin in 1:1 DMSO:PBS for 72 hours at room temperature. After treatment, spore strips were washed with sterile water and dehydrated with increasing concentrations of ethanol (70%, 80%, 90%, and 100%) and subjected to critical point drying. The spore strips were mounted onto a stage, sputter coated with gold, and visualized under a scanning electron microscopy (Hitachi S-4500 Cold Field Emission SEM, Hitachi, Ltd., Tokyo, Japan).

Results:

Scanning electron microscopy was performed to evaluate the morphology of B. subtilis spores. SEM evaluation of all spore strips demonstrated spores seated deep within the matrix of the strips with very few spores located superficially. Spores on untreated spore strips demonstrated no appreciable morphological differences when compared to spores subjected to 1:1 DMSO:PBS without genipin or spores exposed to high (10%)- and low (0.63%)-dose genipin in 1:1 DMSO:PBS (FIG. 10a-d).

### Example 11

### Sterilization of B. Pumilus and Geobacillus Stearothermophilus

Spore strips of B. pumilus (ATCC 27142) with 1.9×10⁶ spores (SGM Biotech, Bozeman, Mont.) and G. stearothermophilus (ATCC 7953) with 1.9×10⁶ spores (SGM Biotech, Bozeman, Mont.) were treated with doses of genipin equivalent to those that sterilized of B. subtilis. B. pumilus conventional spore strips were treated with 1.75 mL of solution and G stearothermophilus mini spore strips were treated with 0.5 mL of solution. Spore strips were treated with 1:1 DMSO:PBS; 2.6 mg, 8.3 mg, 25 mg, and 45 mg genipin per 10⁶ spores in 1:1 DMSO:PBS; and 10% formalin (N=4). After treatment for 72 hours spore strips were washed and transferred to soybean-casein medium (Becton Dickinson, Franklin Lanes, N.J.). B. pumilus was incubated at 32.5° C. and G stearothermophilus was incubated at 57.5° C.

Results:

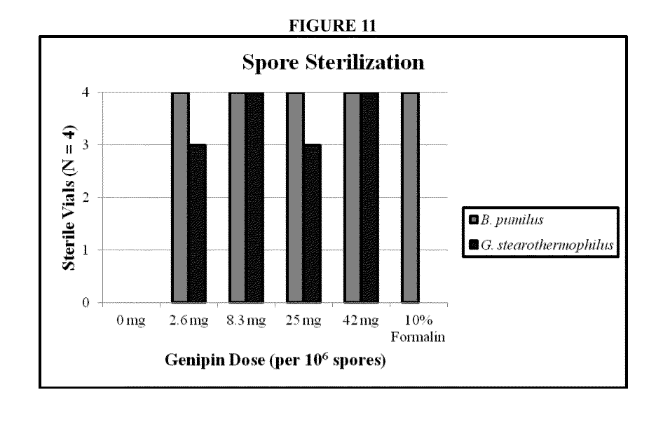

After 72 hours of genipin treatment and one week of incubation, both B. pumilus and G stearothermophilus spore strips were sterilized (FIG. 11). Assuming a 6-log reduction (1.9 viable spores per strip), 15.0% sterile spore strips and 85.0% non-sterile strips for both spore populations was expected. At all genipin doses, 4/4 B. pumilus spore strips were sterilized (chi square p<0.001, 99% one-sided CI=0.32). Three of 4 G. stearothermophilus spore strips were sterilized by doses of 2.6 mg and 25 mg/10⁶ spores and 4/4 G stearothermophilus spore strips were sterilized by doses of 8.3 mg and 42 mg/10⁶ spores (all chi squares p<0.001; 2.6 mg and 25 mg, 98% one-sided CI=0.18; 8.3 mg and 42 mg, 99% one-sided CI=0.32). Also, all G. stearothermophilus spore strips treated with 10% formalin demonstrated viability.

Statistical Analysis:

A priori power analysis was performed with G*Power (G*Power 3.1.3, Kiel, Germany). To detect at least a one-log difference in population assays, comparing groups at an α=0.05 and power >0.999 required N=3 per group. One-tailed Mann-Whitney U tests were performed for comparing population assay groups. Chi squared tests and binomial exact confidence intervals were performed comparing spore viability against expected spore counts for dichotomous (sterile, non-sterile) growth in medium based on the manufacturer's certificate of analysis (COA), and the population assays (PA, for B. subtilis only) [88, 89], using Minitab 16 (Minitab, Inc., State College, Pa.). Statistical significance was set at p≦0.05.

### Discussion

For genipin to be considered a sterilant, a sterility assurance level (SAL) of 10⁻³ to 10⁻⁶ must be achieved [90]. Sterile devices that will only have dermal contact require a SAL of 10⁻³, but for implantable devices, the US Food and Drug Administration requires a SAL of 10^{-6 [}91]. Thus, a 6-log reduction is the goal for a sterilizing process for transplantable tissue.

The approach to determining a minimum sterilizing dose was based on a progression from the pilot work. It was demonstrated with population assays that using 0.63% genipin in PBS led to a 2-log reduction in B. subtilis viability after a one week treatment (unpublished pilot data). Using PBS, genipin's solubility was limited, however, genipin is substantially more soluble in organic solvents, such as DMSO.

DMSO is an appealing solvent as its pharmacological activities include membrane penetration and improved efficacy of drug activity [92, 93]. Clinically, it has been used topically at doses up to 100% and is well tolerated [94-97]. A review of 34,000 stem cell transplants revealed transplanting stem cells cryopresevered with 10% DMSO led to a toxicity incidence of 1.5%, including cardiovascular, respiratory, central nervous system, and renal side effects, but washing DMSO off of treated stems cells or cryopreserving stem cells treated with less than 10% DMSO led to a 0.3% toxicity rate [98]. Also applicable, at concentrations from 8 to 40% (most 20-40%) DMSO was microbicidal in over 40 bacterial (non-spore forms) and fungal species [99].

In the current series of experiments, time-, dose-, and solvent-dependent requirements for eradication of B. subtilis with genipin was demonstrated. High-dose genipin was unable to sterilize any spore strips at any dose after 24 hours of treatment at room temperature. In contrast, with doses of 2.6 mg-42 mg/10⁶ spores sterilize with 72 hours of treatment was possible. Although it is not necessary to understand the mechanism of an invention, it is believed that since the free amino content of genipin-fixed tissues plateaus around 24 hours [100], it was suspected significant sporicidal activity occurs within 24 hours, but that complete kill takes more time. Although it is not necessary to understand the mechanism of an invention, it is believed that lowering the genipin dose revealed that genipin doses of at least 2.6 mg/10⁶ spores are necessary for eradication of B. subtilis, but also, that it has no independent sporicidal activity; the synergistic relationship between DMSO and genipin is sporicidal.

Although it is not necessary to understand the mechanism of an invention, it is believed that DMSO may enhance genipin's activity at the spore coat and cortex, or it may allow intracellular genipin penetration. SEM images of untreated spores and genipin-treated spores demonstrated no morphological changes, leading to conclusions that the sporicidal activity of genipin is either secondary to inhibition of binary fission or preventing spore germination by stabilizing the spore form; it is also plausible that DMSO facilitates genipin penetration intracellularly to crosslink DNA, RNA, or other proteins. Although it is not necessary to understand the mechanism of an invention, it is believed that the inadequacy of genipin solubilized in PBS may be due to genipin's activity being restricted superficially about the spore preventing it from sufficiently crosslinking the outer spore layers or intracellular proteins.

Using genipin as a sterilant for implantable devices and grafts is favorable due to its safety. Treating bovine pericardia with 0.625% genipin in PBS, Sung et al. demonstrated substantial fibroblast proliferation on genipin-treated tissues within three days, in contrast to no cellular proliferation on 0.625% glutaraldehyde-treated pericardia after seven days [18]. They determined genipin to be approximately 10,000× less cytotoxic than glutaraldehyde and the proliferative capacity of the fibroblasts was about 5,000× greater in the genipin group than the glutaraldehyde group [1]. Collagen matrices crosslinked with 0.625% genipin have been shown to permit mesenchymal stem cell migration [101] and differentiation [102]. Further, bovine nucleus pulposus cells entrapped within chitosan gels crosslinked with 5% genipin demonstrated up to 87% viability [103]. However, when cells are directly exposed to genipin solution, 80-100 ppm are sufficient for cytotoxicity of fibroblasts [1] and osteoblasts [104]. This demonstrates an important difference between exposing cells directly to genipin solution and to genipin-treated tissues [105]; therefore, any tissue sterilized with genipin must be sufficiently washed before implantation.

Strengths of this research include the breadth of genipin doses employed, variety of bacterial spores tested, and the assays used to detect spore viability. Bacterial spore strips provide a known quantity of bacterial spores that allow for simplified evaluation of a sterilization process. While this is not the standard method for assessing liquid chemical sterilization [82], without any prior knowledge of genipin's efficacy as a sterilant, these experiments provide a valid initial series of tests. Of note, the spore strips employed in this research were could not be created such that the only bacteria on the strip was the identified bacterial spore, but due to strip processing, bacteria typical of routine handling such as staphylococcus and streptococcus were likely contaminating the strips. The 6-log reductions detected here represent eradication of B. subtilis, B. pumilus, and G. stearothermophilus, as well as the non-spore contaminants. By allowing the spores to germinate and reproduce in medium, the absence of a single viable spore was demonstrated. Notably, G. stearothermophilus was found to grow from 100% of the formalin treated spore strips, requiring 2.25±0.50 days to demonstrate viability. G. stearothermophilus has previously been shown to be incompletely eradicated by 10% formalin treatment [106], but not to the extent seen here, possibly a consequence of treatment conditions (in the cited reference, over 100× more formalin was used) or the biological indicators employed. Regardless, any level of formalin-resistance indicates that genipin sterilization may be a safer, more potent treatment than formalin sterilization.

The limitations of this research center on its small-scale and limited scope. To establish genipin-sterilization as an alternative method of sterilization, the eradication of numerous species of bacteria, fungi, and viruses (including HIV and hepatitis B and C) needs to be established. Future work will focus on optimizing the genipin sterilization process and determining the efficacy of genipin sterilization after penetration of bone and soft tissues. Genipin sterilization may be appropriate for sterilizing any biomaterial where the reduction in bioburden and the mechanical advantages provided by crosslinks are desirable.

### Example 12

### Sterilzation of B. Subtilis Mini Spore Strips

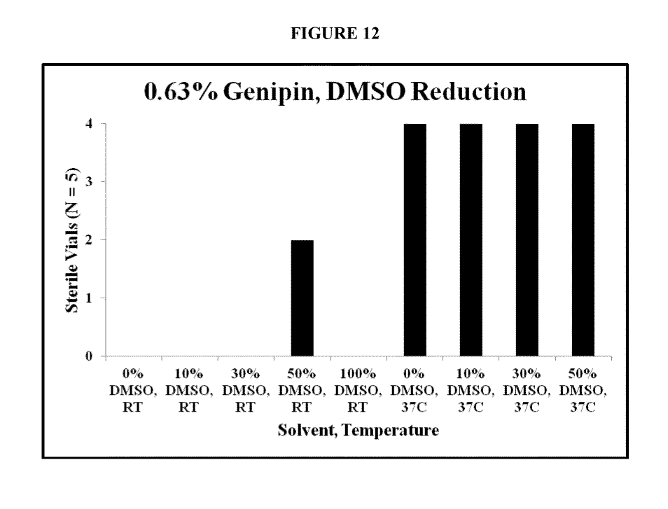

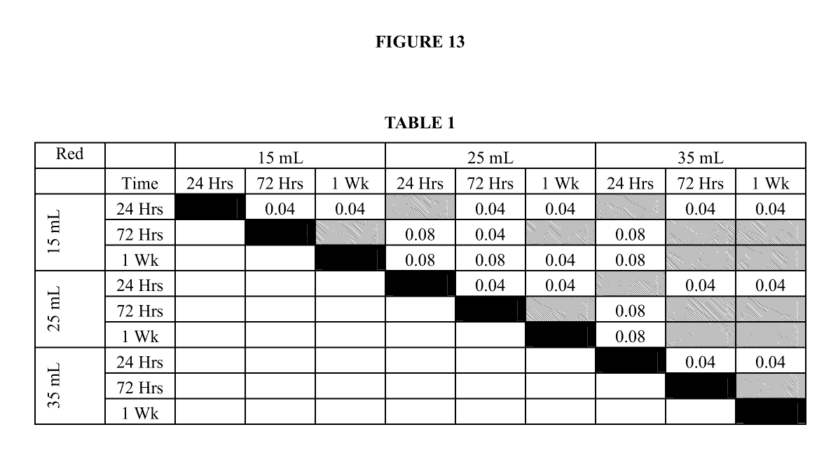

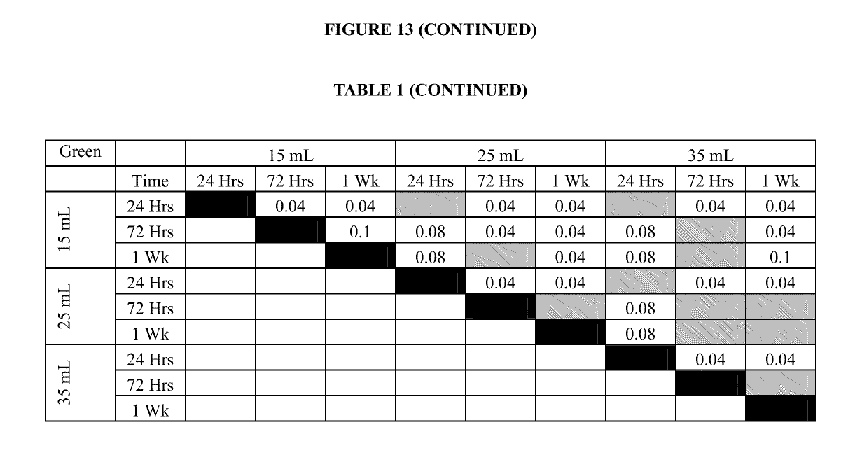

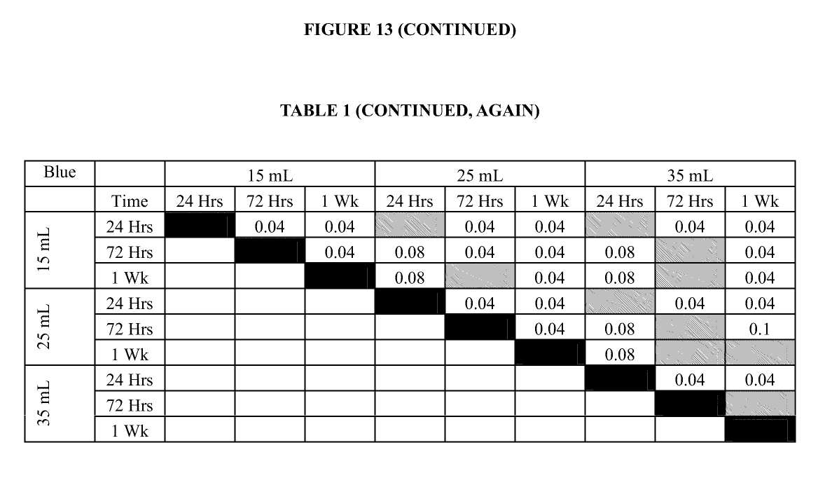

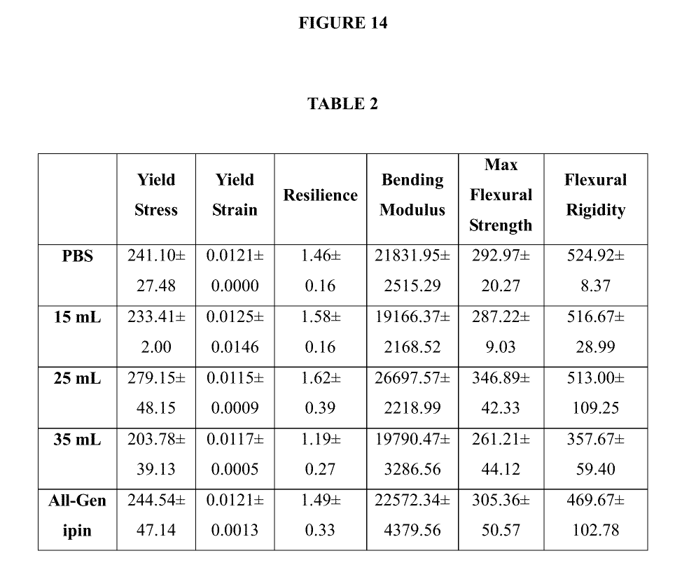

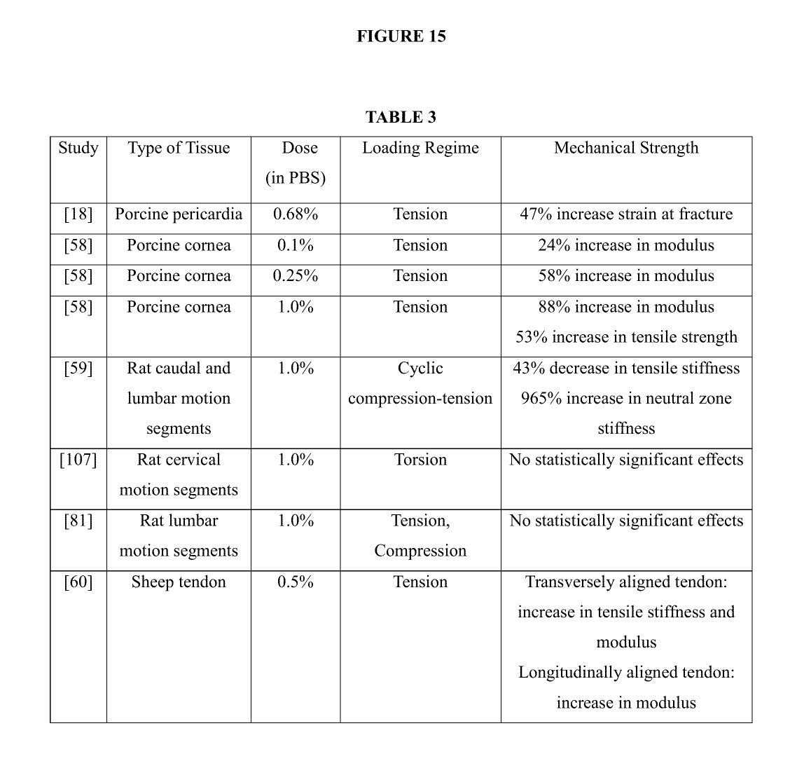

In recent experiments, B. subtilis mini spore strips were sterilized without DMSO (100% PBS) when increasing the treatment temperature to 37° C. In a trial (FIG. 12), 2/5 sterile vials were observed with 0.63% genipin in 50% DMSO/50% PBS at room temperature (RT). This is consistent with at least a 5-log reduction (99% one-sided CI=0.03), but not more than a 6-log. At all doses of DMSO (0-50%), 0.63% genipin sterilized 5/5 vials with 0.63% genipin at 37° C. (99% one-sided CI=0.40). These results are not inconsistent with the prior data, however, the data suggests a narrower sporicidal range for 72-hour, 0.63% genipin treatment in 1:1 DMSO:PBS at room temperature (a 6-log reduction (greater than 5-log reductions but not greater than 7-log reductions)). Meanwhile, increasing the temperature to 37° C. allows 0.63% genipin in PBS to induce at least a 6-log reduction in spore viability. As before, due to the 1.2×10⁶ spores on the spore strips, greater than 6-log reductions with an N=5 was not demonstrated, however, it was hypothesize that just as with genipin-treatment at room temperature, the addition of DMSO will facilitate genipin's sporicidal efficacy and provide a greater logarithmic reduction in spore viability when compared to genipin-treatment in PBS alone.

### Example 13

### Mechanics Testing of Bone

N=7-9 per group., Groups: PBS, 0.63% genipin in PBS, 90% ethanol, 2% genipin in 90% ethanol. Bones were cut to 20 mm×3 mm×0.5 mm, bovine femoral diaphysis. Treatment was for 1 week at room temp (25° C.). Mann Whitney U tests done comparing genipin/pbs v pbs and genipin/ethanol v ethanol alone. Outcomes measured: Stiffness, Ultimate Load, Ultimate Disp., Yield Load, Yield Displacement, Elastic Work, Yield Stress, Yield Strain, Resilience, Bending Modulus, Max. Flexural Strength, Flexural Rigidity. No statistically significant differences using 1-tailed testing at alpha=0.05 for 0.63% genipin inpbs vs. pbs OR 2% genipin in 90% ethanol vs. 90% ethanol alone.

Thus, specific compositions and methods of sterilization of proteinaceous biomaterials and tissues with genipin have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

### REFERENCES

1. Sung, H. W. et al. (1999) In vitro evaluation of cytotoxicity of a naturally occurring cross-linking reagent for biological tissue fixation, J. Biomater. Sci. Polym. Ed. 10(1), 63-78.
2. Tsai, C.-C. et al. (2000) In vitro evaluation of the genotoxicity of a naturally occurring crosslinking agent (genipin) for biologic tissue fixation, J. Biomed. Mater. Res. 52(1), 58-65.
3. Di Lullo, G. A. et al. (2002) Mapping the Ligand-binding Sites and Disease-associated Mutations on the Most Abundant Protein in the Human, Type I Collagen, J. Biol. Chem. 277(6), 4223-4231.
4. Hood, A. F. et al. (1987) Acute Graft-vs-Host Disease: Development Following Autologous and Syngeneic Bone Marrow Transplantation, Arch. Dermatol. 123(6), 745-750.
5. Zittoun, R. A. et al. (1995) Autologous or Allogeneic Bone Marrow Transplantation Compared with Intensive Chemotherapy in Acute Myelogenous Leukemia, N. Engl. J. Med. 332(4), 217-223.
6. Glowacki, J. and Mizuno, S. (2008) Collagen scaffolds for tissue engineering, Biopolymers 89(5), 338-344.
7. Smestad, T. L., Mcpherson, J., and Wallace, D. G. “Injectable cross-linked collagen implant material,” U.S. Pat. No. 4,582,640 application Ser. No. 06/663,478, filed Oct. 22, 1984. (Published Apr. 15, 1986).
8. Kelman, C. D. and Devore, D. P. “Biologically compatible collagenous reaction product and articles useful as medical implants produced therefrom,” U.S. Pat. No. 5,104,957 application Ser. No. 07/486,558, filed Feb. 28, 1990. (Published Apr. 14, 1992).
9. Scopelianos, A. G. et al. “Injectable microdipersions for soft tissue repair and augmentation,” U.S. Pat. No. 5,728,752 application Ser. No. 08/618,439, filed Mar. 15, 1996. (Published Mar. 17, 1998).
10. Dunn, R. L. et al. “Biodegradable in-situ forming implants and methods of producing the same,” U.S. Pat. No. 5,739,176 application Ser. No. 08/210,891, filed Mar. 18, 1994. (Published Apr. 14, 1998).
11. Kelman, C. D. and Devore, D. P. “Human collagen processing and autoimplant use,” U.S. Pat. No. 4,969,912 application Ser. No. 07/157,638, filed Feb. 18, 1988. (Published Nov. 13, 1990).
12. Kelman, C. D. and Devore, D. P. “Human collagen processing and autoimplant use,” U.S. Pat. No. 5,332,802 application Ser. No. 07/897,562, filed Jun. 11, 1992. (Published Jul. 26, 1994).
13. Griffey, E. S. et al. “Particulate acellular tissue matrix,” U.S. Pat. No. 6,933,326 application Ser. No. 09/762,174, filed Jun. 18, 1999. (Published Aug. 23, 2005).
14. Griffey, E. S. et al. “Particulate acellular tissue matrix,” U.S. Pat. No. 7,358,284 application Ser. No. 11/040,127, filed Jan. 20, 2005. (Published Apr. 15, 2008).
15. Xi-xun, Y. et al. (2010) In vitro study in the endothelial cell compatibility and endothelialization of genipin-crosslinked biological tissues for tissue-engineered vascular scaffolds, Journal of Materials Science. Materials in Medicine 21(2), 777-785.
16. Bhrany, A. D. et al. (2008) Crosslinking of an oesophagus acellular matrix tissue scaffold, J. Tissue Eng. Regen. Med. 2(6), 365-372.
17. Englert, C. et al. (2007) Bonding of articular cartilage using a combination of biochemical degradation and surface cross-linking, Arthritis Res. Ther. 9(3), R47.
18. Sung, H.-W. et al. (2003) Crosslinking of biological tissues using genipin and/or carbodiimide, Journal of Biomedical Materials Research Part A 64A(3), 427-438.
19. Lima, E. G. et al. (2009) Genipin enhances the mechanical properties of tissue-engineered cartilage and protects against inflammatory degradation when used as a medium supplement, Journal of Biomedical Materials Research Part A 91A(3), 692-700.
20. Sung, H.-w. and Liang, H.-c. “Acellular biological material chemically treated with genipin,” U.S. Pat. No. 6,545,042 application Ser. No. 10/067,130, filed Feb. 4, 2002. (Published Apr. 8, 2003).
21. Sung, H.-w., Liang, H.-c., and Tu, H. “Acellular biological material chemically treated with genipin,” U.S. Pat. No. 6,998,418 application Ser. No. 10/408,176, filed Apr. 7, 2003. (Published Feb. 14, 2006).
22. Lin, C.-k., Lee, H. L. L., and Sung, H.-w. “Chemical modification of biomedical materials with genipin,” U.S. Pat. No. 6,608,040 application Ser. No. 09/297,808, filed Sep. 27, 2001. (Published Aug. 19, 2003).
23. Chen, C.-N. et al. (2002) Feasibility study using a natural compound (reuterin) produced by Lactobacillus reuteri in sterilizing and crosslinking biological tissues, J. Biomed. Mater. Res. 61(3), 360-369.
24. Santos, N. C. et al. (2003) Multidisciplinary utilization of dimethyl sulfoxide:pharmacological, cellular, and molecular aspects, Biochem. Pharmacol. 65, 1035-1041.
25. Tischler, M. and Misch, C. E. (2004) Extraction site bone grafting in general dentistry. Review of applications and principles, Dent. Today 23(5), 108-113.
26. Levine, S. S., Prewett, A. B., and Cook, S. D. (1992) The use of a new form of allograft bone in implantation or osseointegrated dental implants—a preliminary report, J. Oral Implantol. 18(4), 366-371.
27. Perrott, D. H., Smith, R. A., and Kaban, L. B. (1992) The use of fresh frozen allogeneic bone for maxillary and mandibular reconstruction, Int. J. Oral Maxillofac. Surg. 21(5), 260-265.
28. Ellis, E., 3rd and Sinn, D. P. (1993) Use of homologous bone in maxillofacial surgery, J. Oral Maxillofac. Surg. 51(11), 1181-1193.
29. Jackson, I. T., Helden, G., and Marx, R. (1986) Skull bone grafts in maxillofacial and craniofacial surgery, J. Oral Maxillofac. Surg. 44(12), 949-955.
30. Salyer, K. E. and Taylor, D. P. (1987) Bone grafts in craniofacial surgery, Clin. Plast. Surg. 14(1), 27-35.
31. Citardi, M. J. and Friedman, C. D. (1994) Nonvascularized autogenous bone grafts for craniofacial skeletal augmentation and replacement, Otolaryngol. Clin. North Am. 27(5), 891-910.
32. Breidahl, A. F., Klug, G. L., and Holmes, A. D. (2005) Allogeneic membranous bone grafting for a large calvarial defect, Plast. Reconstr. Surg. 115(3), 43e-49e.
33. Yoshida, Y., Osaka, S., and Mankin, H. J. (2000) Hemipelvic allograft reconstruction after periacetabular bone tumor resection, J. Orthop. Sci. 5(3), 198-204.
34. Doi, K., Kawai, S., and Shigetomi, M. (1996) Congenital tibial pseudoarthrosis treated with vascularised bone allograft, Lancet 347(9006), 970-971.
35. Upton, J. and Glowacki, J. (1992) Hand reconstruction with allograft demineralized bone: twenty-six implants in twelve patients, J. Hand Surg. [Am] 17(4), 704-713.
36. Giannoudis, P. V., Dinopoulos, H., and Tsiridis, E. (2005) Bone substitutes: an update, Injury 36 Supplement 3, S20-27.
37. Burchardt, H. (1983) The biology of bone graft repair, Clin. Orthop. (174), 28-42.
38. Cypher, T. J. and Grossman, J. P. (1996) Biological principles of bone graft healing, J. Foot Ankle Surg. 35(5), 413-417.
39. Friedlaender, G. E. (1983) Immune responses to osteochondral allografts. Current knowledge and future directions, Clin. Orthop.(174), 58-68.
40. Boyce, T., Edwards, J., and Scarborough, N. (1999) Allograft bone. The influence of processing on safety and performance, Orthop. Clin. North Am. 30(4), 571-581.
41. Friedlaender, G. E. et al. (1999) Long-term follow-up of patients with osteochondral allografts. A correlation between immunologic responses and clinical outcome, Orthop. Clin. North Am. 30(4), 583-588.
42. Conrad, E. U. et al. (1995) Transmission of the hepatitis-C virus by tissue transplantation, Journal of Bone and Joint Surgery 77(2), 214-224.
43. Simonds, R. J. et al. (1992) Transmission of human immunodeficiency virus type 1 from a seronegative organ and tissue donor, N. Engl. J. Med. 326(11), 726-732.
44. Eisenbrey, A. B. and Frizzo, W. (2005) Tissue banking regulations and oversight, Clin. Lab. Med. 25(3), 487-498.
45. Woll, J. E. (2005) Tissue banking overview, Clin. Lab. Med. 25(3), 473-486.
46. Bright, R. W., Smarsh, J. D., and Gambill, V. M. (1983) Sterilization of human bone by irradiation, in Osteochondral Allografts: Biology, Banking and Clinical Applications (Friedlaender, G. E., Mankin, H. J., and Sell, K. W., Eds.), pp 223-232, Little, Brown and Company, Boston.
47. Bright, R. W. and Burchardt, H. (1983) The biomechanical properties of preserved bone grafts, in Osteochondral allografts: Biology, Banking and Clinical Applications (Friedlaender, G. E., and Sell, K. W., Eds.), pp 241-247, Little, Brown and Company, Boston.
48. Campbell, D. G. and Li, P. (1999) Sterilization of HIV with irradiation: relevance to infected bone allografts, ANZ J. Surg. 69(7), 517-521.
49. Hamer, A. J., Stockley, I., and Elson, R. A. (1999) Changes in allograft bone irradiated at different temperatures, J. Bone Joint Surg. Br. 81(2), 342-344.
50. Cheung, D. T. et al. (1990) The effect of gamma-irradiation on collagen molecules, isolated alpha-chains, and crosslinked native fibers, J. Biomed. Mater. Res. 24, 581-589.
51. Bailey, A. J. (1967) Irradiation-induced changes in the denaturation temperature and intermolecular cross-linking of tropocollagen, Radiat. Res. 31, 206-214.
52. Colwell, A. et al. (1996) To determine the effects of ultraviolet light, natural light and ionizing radiation in the pyridinium cross-links in bone and urine using high-performance liquid chromatography, Eur. J. Clin. Investig. 26, 1107-1114.
53. Salehpour, A. et al. (1995) Dose-dependent response of gamma irradiation on mechanical properties and related biochemical composition of goat bone-patellar tendon-bone allografts, J. Orthop. Res. 13(6), 898-906.
54. Komender, A. (1976) Influence of preservation on some mechanical properties of human haversian bone, Mater. Med. Pol. 8(1), 13-17.
55. Currey, J. D. et al. (1997) Effects of ionizing radiation on the mechanical properties of human bone, J. Orthop. Res. 15(1), 111-117.
56. Hamer, A. J. et al. (1996) Biomechanical properties of cortical allograft bone using a new method of bone strength measurement. A comparison of fresh, fresh-frozen and irradiated bone, J. Bone Joint Surg. Br. 78(3), 363-368.
57. Fujikawa, S. et al. (1987) The continuous hydrolysis of geniposide to genipin using immobilized beta-glucosidase on calcium alginate gel, Biotechnol. Lett. 9(10), 697-702.
58. Avila, M. Y. and Navia, J. L. (2010) Effect of genipin collagen crosslinking on porcine corneas, J. Cataract Refract. Surg. 36(4), 659-664.
59. Barbir, A. et al. (2010) Effects of enzymatic digestion on compressive properties of rat intervertebral discs, J. Biomech. 43(6), 1067-1073.
60. Van Kleunen, J. P. and Elliott, D. M. (2003) Effect of a natural crosslinking agent (genipin) on tendon longitudinal and transverse tensile properties, in Summer Bioengineering Conference, pp 1-2, Key Biscayne, Fla.
61. McDonnell, G. and Russell, A. D. (1999) Antiseptics and disinfectants: activity, action, and resistance, Clin. Microbiol. Rev. 12(1), 147-179.
62. The, S. D. (1975) Long-distance bactericidal and fungicidal effectiveness of parachlorophenol and Formalin on Streptococcus faecalis and Candida albicans, J. Endod. 1(9), 300-302.
63. Lelono, R. A., Tachibana, S., and Itoh, K. (2009) Isolation of antifungal compounds from Gardenia jasminoides, Pak. J. Biol. Sci. 12(13), 949-956.
64. Moon, S. H. et al. “Genipin derivative having anti hepatitis B virus activity,” U.S. Pat. No. 6,162,826 application Ser. No. 09/284,540 filed Apr. 14, 1999. (Published Dec. 19, 2000).
65. Joyce, M. J. et al. (2008) Musculoskeletal Allograft Tissue Safety, in American Academy of Orthopaedic Surgeons, AAOS 75th Annual Meeting San Francisco.
66. Jackson, D. W., Corsetti, J., and Simon, T. M. (1996) Biologic incorporation of allograft anterior cruciate ligament replacements, Clin. Orthop. (324), 126-133.
67. Cohen, S. B. and Sekiya, J. K. (2007) Allograft safety in anterior cruciate ligament reconstruction, Clin. Sports Med. 26(4), 597-605.
68. Moore, D. R. et al. (2006) Allograft reconstruction for massive, irreparable rotator cuff tears, Am. J. Sports Med. 34(3), 392-396.
69. Curran, A. R. et al. (2004) The biomechanical effects of low-dose irradiation on bone-patellar tendon-bone allografts, Am. J. Sports Med. 32(5), 1131-1135.
70. Fideler, B. M. et al. (1995) Gamma irradiation: effects on biomechanical properties of human bone-patellar tendon-bone allografts, Am. J. Sports Med. 23(5), 643-646.
71. Hernigou, P. et al. (1993) Massive allografts sterilised by irradiation. Clinical results, J. Bone Joint Surg. Br. 75(6), 904-913.
72. Sun, K. et al. (2009) Anterior cruciate ligament reconstruction with BPTB autograft, irradiated versus non-irradiated allograft: a prospective randomized clinical study, Knee Surg. Sports Traumatol. Arthrosc. 17(5), 464-474.
73. Lietman, S. A. et al. (2000) Complications of irradiated allografts in orthopaedic tumor surgery, Clin. Orthop. (375), 214-217.
74. Rappe, M. et al. (2007) Nonirradiated versus irradiated Achilles allograft: in vivo failure comparison, Am. J. Sports Med. 35(10), 1653-1658.
75. Wilke, H. J., Krischak, S., and Claes, L. E. (1996) Formalin fixation strongly influences biomechanical properties of the spine, J. Biomech. 29(12), 1629-1631.
76. Burkhart, K. J. et al. (2010) Influence of formalin fixation on the biomechanical properties of human diaphyseal bone, Biomed. Tech. (Berl) 55(6), 361-365.
77. Nishi, C., Nakajima, N., and Ikada, Y. (1995) In vitro evaluation of cytotoxicity of diepoxy compounds used for biomaterial modification, J. Biomed. Mater. Res. 29(7), 829-834.
78. NLM. (2011) Formaldehyde, Dynamic Content.
79. Speer, D. P. et al. (1980) Biological effects of residual glutaraldehyde in glutaraldehyde-tanned collagen biomaterials, J. Biomed. Mater. Res. 14(6), 753-764.
80. Tsai, T. H. et al. (1994) Identification and Determination of Geniposide, Genipin, Gardenoside, and Geniposidic Acid from Herbs by HPLC/Photodiode-Array Detection, J. Liq. Chromatogr. 17(10), 2199-2205.
81. Yerramalli, C. S. et al. (2007) The effect of nucleus pulposus crosslinking and glycosaminoglycan degradation on disc mechanical function, Biomech. Model. Mechanobiol. 6(1-2), 13-20.
82. WHO. (2011) Quality Control in Sterilization, World Health Organization Regional Office for South-East Asia, New Delhi, India.
83. Sagripanti, J. L. and Bonifacino, A. (1996) Comparative sporicidal effects of liquid chemical agents, Appl. Environ. Microbiol. 62(2), 545-551.
84. Akkus, O., Adar, F., and Schaffler, M. B. (2004) Age-related changes in physicochemical properties of mineral crystals are related to impaired mechanical function of cortical bone, Bone 34(3), 443-453.
85. Büchi, G. et al. (1967) Total synthesis of racemic genipin, J. Am. Chem. Soc. 89(11), 2776-2777.
86. Touyama, R. et al. (1994) Studies on the blue pigments produced from genipin and methylamin. II. On the formation mechanisms of brownish-red intermediates leading to the blue pigment formation, Chem. Pharm. Bull. (Tokyo) 42(8),1571-1578.
87. United States Pharmacopeia (2002) United States Pharmacopeia 25—National Formulary 20, Webcom Limited, Toronto, Ontario.
88. Halvorson, H. O. and Ziegler, N. R. (1933) Application of Statistics to Problems in Bacteriology: I. A Means of Determining Bacterial Population by the Dilution Method, J. Bacteriol. 25(2), 101-121.
89. Gillis, J. R. et al. (2010) Understanding biological indicator grow-out times, Pharmaceutical Technology 34(1).
90. ISO11139:2006. (2006) International Organization for Standardization. Sterilization of health care products—Vocabulary, Geneva, Switzerland.
91. FDA. (2002) Updated 510(k) Sterility Review Guidance K90-1; Guidance for Industry and FDA, US Food and Drug Administration, Review Procedures for All Sterilization Methods.
92. Jacob, S. W. and Herschler, R. (1986) Pharmacology of DMSO, Cryobiology 23(1), 14-27.
93. Fassel, T. A., Sohnle, P. G., and Kushnaryov, V. M. (1997) The use of dimethylsulfoxide for fixation of yeasts for electron microscopy, Biotech. Histochem. 72(5), 268-272.
94. Scherbel, A. L., McCormack, J. L., and Layle, J. K. (1968) Further Observations on the Effect of Dimethyl Sulfoxide in Patients with Generalized Scleroderma (Progressive Systemic Sclerosis) Ann. N.Y. Acad. Sci. 141(1), 613-629.
95. Bertelli, G. et al. (1995) Topical dimethylsulfoxide for the prevention of soft tissue injury after extravasation of vesicant cytotoxic drugs: a prospective clinical study, Journal of Clinical Oncology 13(11), 2851-2855.
96. Ludwig, C. U. et al. (1987) Prevention of cytotoxic drug induced skin ulcers with dimethyl sulfoxide (DMSO) and alpha-tocopherole, Eur. J. Cancer Clin. Oncol. 23(3), 327-329.
97. Brobyn, R. D. (1975) The human toxicology of dimethyl sulfoxide, Ann. N.Y. Acad. Sci. 243, 497-506.
98. Windrum, P. et al. (2005) Variation in dimethyl sulfoxide use in stem cell transplantation: a survey of EBMT centres, Bone Marrow. Transplant. 36(7), 601-603.
99. Basch, H. and Gadebusch, H. H. (1968) In vitro antimicrobial activity of dimethyl sulfoxide, Appl. Environ. Microbiol. 16(12), 1953-1954.
100. Sung, H. W. et al. (2000) Fixation of biological tissues with a naturally occurring crosslinking agent: fixation rate and effects of pH, temperature, and initial fixative concentration, J. Biomed. Mater. Res. 52(1), 77-87.
101. Gurkan, U. A. et al. (2010) Comparison of morphology, orientation, and migration of tendon derived fibroblasts and bone marrow stromal cells on electrochemically aligned collagen constructs, Journal of Biomedical Materials Research Part A 94(4), 1070-1079.
102. Kishore, V. et al. (2012) Tenogenic differentiation of human MSCs induced by the topography of electrochemically aligned collagen threads, Biomaterials 33(7), 2137-2144.
103. Mwale, F. et al. (2005) Biological evaluation of chitosan salts cross-linked to genipin as a cell scaffold for disk tissue engineering, Tissue Eng. 11(1-2), 130-140.
104. Liu, B. S. et al. (2003) In vitro evaluation of degradation and cytotoxicity of a novel composite as a bone substitute, Journal of Biomedical Materials Research Part A 67(4), 1163-1169.
105. Dare, E. V. et al. (2009) Genipin cross-linked fibrin hydrogels for in vitro human articular cartilage tissue-engineered regeneration, Cells Tissues Organs 190(6), 313-325.
106. Dominici, J. T. et al. (2001) Disinfection/sterilization of extracted teeth for dental student use, J. Dent. Educ. 65(11), 1278-1280.
107. Barbir, A. et al. (2011) Effects of Torsion on Intervertebral Disc Gene Expression and Biomechanics, Using a Rat Tail Model, Spine 36(8), 607-614.

We claim:

1. A method of sterilizing protein-based tissue, comprising:
(a) preparing and sterilizing a minimum 10% genipin solution, and
(b) treating said protein-based tissue with said prepared, sterilized minimum 10% genipin solution under such conditions that produce a sterile crosslinked structure.

2. The method of claim 1, wherein said crosslinked structure has stability to degradative enzymes.

3. The method of claim 1, wherein said crosslinked structure has low acute toxicity.

4. The method of claim 1, wherein said crosslinked structure has durability sufficient for use as a biocompatible implant.

5. The method of claim 1, wherein said preparing and sterilizing a minimum 10% genipin solution comprises:
(a) dissolving genipin in dimethyl sulfoxide at least 20 grams per 100 mL solution,
(b) adding an equal volume of phosphate buffered saline to said solution,
(c) agitating the solution, and
(d) sterile filtering the solution.

6. The method of claim 1, wherein said treating comprises minimum 24 hours between room temperature and 37° C. for tissue less than 1 millimeter thick.

7. The method of claim 6, wherein said tissue is post-treated in another solution not containing genipin, such as 100% PBS or 90% ethanol.

8. The method of claim 1, wherein said treating comprises minimum 168 hours between room temperature and 37° C. for tissue greater than 1 millimeter thick.

9. The method of claim 8, wherein said tissue is post-treated in another solution not containing genipin, such as 100% PBS or 90% ethanol.

10. The method of claim 1, wherein said treating comprises soaking said protein-based tissue with said prepared, sterilized minimum 10% genipin solution within 15 minutes of the solution preparation.

11. The method of claim 1, wherein said treating sterilizes the tissues through crosslinking the organic framework of microbes while maintaining or enhancing mechanical strength of the tissue.

12. The method of claim 1, wherein said protein-based tissue is selected from the group consisting of: collagen-based hard and soft tissue from animal and human donors or synthetically created tissue.

13. The method of claim 12, wherein said protein-based tissue is selected from the group consisting of: bone, cartilage, tendon, ligament, collagen scaffold, collagen substrate, tissue mesh, cornea, and heart valve.

14. The method of claim 1, wherein said treating occurs at a maximum temperature just below the substrate's denaturation temperature.

15. The method of claim 1, where said solution is prepared with at least one organic solvent.

16. The method of claim 15, where said organic solvent is dimethyl sulfoxide.

17. The method of claim 15, where said organic solvent is dimethylformamide.

18. The method of claim 1, wherein said treatment occurs at a pressure is selected from the group consisting of atmospheric pressure, within a pressurized system, within a negative pressure environment, or under vacuum.

19. The methods of claim 1, wherein said solution is prepared in a cold environment, and treatment occurs at temperatures ≧25° C.

20. The methods of claim 19, wherein said cold environment is <10° C.

21. The methods of claim 1, wherein said treatment reduces bioburden allowing for decreasing the dose of alternative sterilization process.

22. The methods of claim 21, wherein said treatment occurs before the alternative sterilization process.

23. The methods of claim 21, wherein said treatment occurs after the alternative sterilization process.

24. A method of sterilizing protein-based tissue, comprising:
(a) preparing and sterilizing a minimum 0.01% genipin solution, and
(b) treating said protein-based tissue with said prepared, sterilized minimum 0.01% genipin solution under such conditions that produce a sterile crosslinked structure.

25. The method of claim 24, wherein said crosslinked structure has stability to degradative enzymes.

26. The method of claim 24, wherein said crosslinked structure has low acute toxicity.

27. The method of claim 24, wherein said crosslinked structure has durability sufficient for use as a biocompatible implant.

28. The method of claim 24, wherein said preparing and sterilizing a minimum 0.01% genipin solution comprises:
(a) dissolving genipin in phosphate buffered saline at least 0.02 grams per 100 mL solution, or
(b) agitating the solution, and
(c) sterile filtering the solution.

29. The method of claim 24, wherein said treating comprises minimum 72 hours between room temperature and 37° C. for tissue less than 1 millimeter thick.

30. The method of claim 29, wherein said tissue is post-treated in another solution not containing genipin, such as 100% PBS or 90% ethanol.

31. The method of claim 24, wherein said treating comprises minimum 168 hours between room temperature and 37° C. for tissue greater than 1 millimeter thick.

32. The method of claim 31, wherein said tissue is post-treated in another solution not containing genipin, such as 100% PBS or 90% ethanol.

33. The method of claim 24, wherein said treating comprises soaking said protein-based tissue with said prepared, sterilized minimum 0.63% genipin solution within 15 minutes of the solution preparation.

34. The method of claim 24, wherein said treating occurs at a maximum temperature just below the substrate's denaturation temperature.

35. The method of claim 24, where said solution is prepared with at least one organic solvent.

36. The method of claim 35, where said organic solvent is dimethyl sulfoxide.

37. The method of claim 35, where said organic solvent is dimethylformamide.

38. The method of claim 24, wherein said treatment occurs under various pressures selected from the group consisting of: atmospheric pressure, within a pressurized system, within a negative pressure environment, or under vacuum.

39. The methods of claim 24, wherein said solution is prepared in a cold environment, <10° C., and treatment occurs at temperatures ≧25° C.

40. The methods of claim 24, wherein said treatment reduces bioburden allowing for decreasing the dose of alternative sterilization process.

41. The methods of claim 40, wherein said treatmentoccurs before an alternative sterilization process.

42. The methods of claim 40, wherein said treatmentoccurs after an alternative sterilization process.

43. A method of sterilizing non-protein based materials contaminated with protein-based matter, comprising:
(a) preparing and sterilizing a minimum 10% genipin solution, and
(b) treating said non-protein-based material with said prepared, sterilized minimum 10% genipin solution under such conditions that produce a sterile structure with crosslinked bioburden.

44. The method of claim 43, wherein said preparing and sterilizing a minimum 10% genipin solution comprises:
(a) dissolving genipin in dimethyl sulfoxide at least 20 grams per 100 mL solution,
(b) adding an equal volume of phosphate buffered saline to said solution,
(c) agitating the solution, and
(d) sterile filtering the solution.

45. The method of claim 43, wherein said treating comprises minimum 24 hours between room temperature and 37° C.

46. The method of claim 43, wherein said treating comprises soaking said protein-based tissue with said prepared, sterilized minimum 10% genipin solution within 15 minutes of the solution preparation.

47. The method of claim 43, wherein said treating sterilizes the material through crosslinking the organic framework of microbes.

48. The method of claim 43, wherein said non-protein based material is a biocompatible implant.

49. The method of claim 43, wherein said non-protein based material consists of polyethylene, metals, surgical equipment, and plastics.

50. A method of non-organic materials contaminated with protein-based matter, comprising:
(a) preparing and sterilizing a minimum 0.01% genipin solution, and
(b) treating said material protein-based tissue with said prepared, sterilized minimum 0.01% genipin solution under such conditions that produce a sterile structure with crosslinked bioburden.

51. The method of claim 50, wherein said non-organic material is a biocompatible implant.

52. The method of claim 50, wherein said treating comprises minimum 24 hours between room temperature and 37° C. of a washed non-protein based material.

53. The method of claim 50, wherein said treating comprises soaking said protein-based tissue with said prepared, sterilized minimum 0.01% genipin solution within 15 minutes of the solution preparation.

54. The method of claim 50, wherein said treating sterilizes the material through crosslinking the organic framework of microbes.

55. The method of claim 50, wherein said non-protein based material is a biocompatible implant.

56. The method of claim 50, wherein said non-protein based material consists of polyethylene, metals, surgical equipment, and plastics.
